(19) United States
(12) Patent Application Publication
(10) Pub. No.: US 2026/0058535 A1
(43) Pub. Date: Feb. 26, 2026

(54) ELECTRIC WORK MACHINE

(71) Applicant: MAKITA CORPORATION, ANJO-SHI (JP)

(72) Inventors: Ryoto KAWAKAMI, Anjo-Shi (JP); Hajime YAMAO, Anjo-Shi (JP)

(21) Appl. No.: 19/302,165

(22) Filed: Aug. 18, 2025

(30) Foreign Application Priority Data
Aug. 22, 2024 (JP) 2024-141040

(51) Int. Cl. H02K 21/22; B25F 5/02; H02K 7/14

(52) U.S. Cl. CPC H02K 21/22; B25F 5/02; H02K 7/145; H02K 2213/03

(57) ABSTRACT

An electric work machine includes a brushless motor (6) and a motive-power-transmitting part (13). The brushless motor is in the form of an outer-rotor-type motor. The brushless motor includes a rotor (20) and a stator (30). The rotor has a rotor core (22) and twelve magnetic poles (23; 113; 123). The rotor core is composed of a plurality of first core sheets (2200) laminated to each other. The stator has a stator core (31) and nine coils (33). The stator core is disposed on the inner-circumferential side of (within) the rotor core and has nine teeth (31B). The stator core is composed of a plurality of second core sheets (3100) laminated to each other.

### CROSS-REFERENCE

This application claims priority to Japanese patent application no. 2024-141040 filed on Aug. 22, 2024, the contents of which are fully incorporated herein by reference.

### TECHNICAL FIELD

The present disclosure generally relates to an electric work machine, such as a power tool, in which an outer-rotor-type motor is installed.

### BACKGROUND ART

US 2022/416608 (A1) and its family member DE 10 2022 115 705 (A1) disclose an electric work machine (power tool) in which an outer-rotor-type brushless motor is installed.

### SUMMARY OF THE INVENTION

With regard to such an electric work machine, there is demand to make the brushless motor more compact (without sacrificing performance) to improve work efficiency. Accordingly, it is one non-limiting object of the present disclosure to describe techniques for making an outer-rotor-type brushless motor, which will be installed in the electric work machine (e.g., a power tool), more compact (without sacrificing performance).

In the present disclosure, terms such as “first,” “second,” and so forth are merely intended to distinguish elements from each other and are not intended to limit the order or number of elements. Accordingly, the first element may be referred to as the second element, and, similarly, the second element may be referred to as the first element. In addition, the first element may be provided without the second element being provided, and, similarly, the second element may be provided without the first element being provided.

In one non-limiting aspect of the present disclosure, an electric work machine comprises a brushless motor and a motive-power-transmitting part (e.g., a transmission, such as a speed-reducing transmission, a gear train or simply a gear). The brushless motor is in the form of an outer-rotor-type motor. The motive-power-transmitting part transmits rotational force (rotational energy) from the brushless motor to a tool accessory to drive the driven tool accessory.

The brushless motor comprises a rotor and a stator. The rotor comprises a rotor core and twelve magnetic poles. The rotor core has a tubular shape. The rotor core comprises first core sheets laminated to each other. The twelve magnetic poles are disposed spaced apart from each other along the circumferential direction of the rotor core.

The stator comprises a stator core and nine coils. The stator core is disposed on the inner-circumferential side of (i.e. within) the rotor core (so that the rotor core radially surrounds the stator core) and comprises nine teeth. The stator core comprises second core sheets laminated to each other. The nine coils are respectively wound around the nine teeth.

The electric work machine thus configured in which a more compact outer-rotor-type brushless motor can be installed.

### BRIEF DESCRIPTION OF THE DRAWINGS

FIG. 1 is an oblique view of an electric work machine according to an exemplary first embodiment.

FIG. 2 is a first oblique view of a motor and a controller in the interior of the electric work machine.

FIG. 3 is a first exploded, oblique view of the motor.

FIG. 4 is a second oblique view of the motor.

FIG. 5 is a second exploded, oblique view of the motor.

FIG. 6 is a front view of a rotor.

FIG. 7 is a front view of a stator.

FIG. 8 is a cross-sectional view of the motor in a cross section parallel to the right direction and the forward direction and passing through rotational axis AX.

FIG. 9 is an oblique view of a rotor core.

FIG. 10 is an explanatory diagram of a process of laminating the rotor core.

FIG. 11 is an exploded, oblique view of a stator base, a stator core, and a first bearing.

FIG. 12 is an explanatory diagram specifically illustrating an aspect in which the stator core is laminated.

FIG. 13 is a front view of the stator core.

FIG. 14 is a cross-sectional view of the stator base, the stator core, and the first bearing in a cross section orthogonal to rotational axis AX and passing through the first bearing.

FIG. 15 is an explanatory diagram that shows the electrical configuration of the electric work machine.

FIG. 16 is an explanatory diagram of various dimensions used when investigating the optimal design of the motor.

FIG. 17 is an explanatory graph of back EMF generated by the motor.

FIG. 18 is an explanatory graph showing results of investigating the minimum value of stator thickness Ds when rotor-core outer diameter ør=55 mm.

FIG. 19 is an explanatory graph showing results of investigating the minimum value of stator thickness Ds when rotor-core outer diameter ør=60 mm.

FIG. 20 is an explanatory graph showing results of investigating the minimum value of stator thickness Ds when rotor-core outer diameter ør=65 mm.

FIG. 21 is an explanatory graph showing results of investigating the minimum value of stator thickness Ds when rotor-core outer diameter ør=70 mm.

FIG. 22 is an explanatory graph showing results of investigating the minimum value of stator thickness Ds when rotor-core outer diameter ør=75 mm.

FIG. 23 is an explanatory diagram showing results of investigating the minimum value of stator thickness Ds when rotor-core outer diameter ør=80 mm.

FIG. 24 is an explanatory graph showing results of investigating motor volume in a 12-pole, 9-slot configuration.

FIG. 25 is an explanatory chart showing results of investigating back-EMF constant k and coefficient α.

FIG. 26 is an explanatory graph showing results of investigating rotor-flatness-ratio density ξr when motor output P=1.0 kW.

FIG. 27 is an explanatory graph showing results of investigating rotor-flatness-ratio density ξr when motor output P=1.5 kW.

FIG. 28 is an explanatory graph showing results of investigating rotor-flatness-ratio density ξr when motor output P=2.0 kW.

FIG. 29 is an explanatory graph showing results of investigating rotor-flatness-ratio density ξr when motor output P=2.4 kW.

FIG. 30 is an explanatory graph showing results of investigating stator-flatness-ratio density ξs when motor output P=1.0 kW.

FIG. 31 is an explanatory graph showing results of investigating stator-flatness-ratio density ξs when motor output P=1.5 kW.

FIG. 32 is an explanatory graph showing results of investigating stator-flatness-ratio density ξs when motor output P=2.0 kW.

FIG. 33 is an explanatory graph showing results of investigating stator-flatness-ratio density s when motor output P=2.4 kW.

FIG. 34 is an explanatory graph showing an example of a pole-slot combination capable of achieving a more compact and lighter motor.

FIG. 35 is an oblique view of the rotor according to a second embodiment.

FIG. 36 is an oblique view of the rotor according to a third embodiment.

### DETAILED DESCRIPTION OF THE INVENTION

### 1. Summary of Embodiments

In some embodiments of the present disclosure, an electric work machine, e.g., a power tool, may have one, some or all of the following features.
Feature 1: A brushless motor.
Feature 2: The brushless motor is an outer-rotor-type motor.
Feature 3: A motive-power-transmitting part.
Feature 4: The motive-power-transmitting part is configured to transmit rotational force of (rotational energy output by) the brushless motor to a tool accessory to drive the tool accessory.
Feature 5: The brushless motor comprises a rotor.
Feature 6: The rotor comprises a rotor core.
Feature 7: The rotor core comprises first core sheets laminated to each other.
Feature 8: The rotor core has a tubular shape.
Feature 9: The rotor has (e.g., has precisely) twelve magnetic poles (or magnetic-pole parts).
Feature 10: The twelve magnetic poles are disposed spaced apart from each other along (around) the circumferential direction of the rotor core.
Feature 11: The brushless motor comprises a stator.
Feature 12: The stator comprises a stator core.
Feature 13: The stator core is disposed on the inner-circumferential side of the rotor core; i.e., the rotor core radially surrounds the stator core.
Feature 14: The stator core comprises second core sheets laminated to each other. Feature 15: The stator core comprises (e.g., has precisely) nine teeth.
Feature 16: The stator comprises (e.g., has precisely) nine coils.
Feature 17: The nine coils are respectively wound around the nine teeth.

In an electric work machine having at least Features 1-17, an outer-rotor-type brushless motor can be made more compact. In addition or in the alternative, it is possible to increase the output (power, performance) of the brushless motor (i.e., to make it compact and high output).

In addition, Feature 7 makes it possible to reduce eddy currents generated in the rotor core (and, in turn, to reduce eddy-current losses in the rotor core). Feature 14 makes it possible to reduce eddy currents generated in the stator core (and, in turn, to reduce eddy-current losses in the stator core).

The circumferential direction may correspond to rotational directions of the rotor core, i.e., the rotational directions of the rotor.

The rotor core may have a circular-stube shape.

Each of the twelve magnetic poles may be disposed so as to face the rotational axis of the rotor. That is, each of the twelve magnetic poles may be disposed such that the N-pole and the S-pole of each of the twelve magnets are aligned (oriented along the radial direction of each magnet.

The twelve magnetic poles may be disposed such that the N-poles and the S-poles, which face the stator core, alternate along the circumferential direction as seen from the stator (i.e., are oriented toward the stator).

In other words, the twelve magnetic poles may be disposed such that the N-poles and the S-poles alternately oppose a prescribed outer-circumferential surface of the stator core as the rotor core rotates.

The twelve magnetic poles may be specifically realized in any form. For example, and without limitation, the twelve magnetic poles may be realized by twelve magnets (e.g., permanent magnets) as described below.

The rotor core may be supported by a support member. The support member may have a cup shape. The rotor core may be fixed to an inner-circumferential side of the support member. Specifically, an outer-circumferential surface of the rotor core may be fixed (e.g., adhesively fixed) to an inner-circumferential surface of the support member.

The rotor may comprise a shaft that is configured to rotate integrally with the rotor. The shaft may be directly or indirectly coupled to the motive-power-transmitting part. The rotational force of the brushless motor (i.e., the rotational force of the rotor) may be transmitted to the motive-power-transmitting part via the shaft.

Each of the first core sheets may have a sheet shape (or a thin-plate shape). Each of the first core sheets may contain a magnetic material (or a magnetic body). More specifically, each of the first core sheets may contain a soft magnetic material. Even more specifically, each of the first core sheets may contain electrical steel, i.e., may be an electrical steel sheet.

The above-mentioned items (features) relating to the plurality of first core sheets are the same for the plurality of second core sheets.

The rotor core has an inner-circumferential surface. The stator core may be disposed such that an outer-circumferential surface of the stator core opposes the inner-circumferential surface of the rotor core.

The stator core may have a circular-tube-shaped back core. The nine teeth may be disposed such that they extend radially outward from the back core. The nine teeth may be formed integrally with the back core. The nine teeth may be disposed equispaced from each other along (around) the circumferential direction. The spaces between each pair of teeth that are adjacent in the circumferential direction may be referred to as slots. In this situation, it may be said that the stator core has nine slots rather than that the stator core comprises nine teeth. The nine coils may be wound around the stator core by using, e.g., a so-called concentrated winding method.

The nine coils may be connected to each other in any manner. For example, the nine coils may be delta-connected or may be star-connected as will be further described below.

The nine coils may be configured to be supplied with electrical power (e.g., three-phase electrical power). The nine coils may be configured to receive electrical power, thereby generating magnetic force. The rotor may be configured to rotate in response to changes in the magnetic force (magnetic fields) generated by the nine coils.

A rotor having twelve magnetic poles may mean that the rotor does not have thirteen or more magnetic poles. The stator core having nine teeth may mean that the stator core does not have ten or more teeth (in other words, does not have ten or more slots).

The tool accessory may be fixed to the electric work machine in a non-detachable manner or may be configured to be mounted on the electric work machine in a detachable manner.

Certain embodiments may have at least any one of the following features in addition to or instead of at least any one of Features 1-17 described above.
Feature 18: The brushless motor has a back-EMF constant k (in V/krpm (kilorevolutions per minute)) that satisfies the condition 1.1≤k≤9.0.
Feature 19: The back-EMF constant k is calculated using numerical formula E/N.
Feature 20: In the numerical formula of Feature 19, N (in krpm) is the rotational speed of the brushless motor.
Feature 21: In the numerical formula of feature 19, E (in V) is a value indicating the magnitude of the back EMF generated by the brushless motor. E (in V) may be a value indicating the magnitude of the back EMF when the brushless motor is rotating at rotational speed N.

In an electric work machine having at least Features 1-21, it becomes possible to make the outer-rotor-type brushless motor installed in the electric work machine more compact. In addition, it may be possible to increase the brushless motor high output (i.e., to make it compact and high output).

Here, the “value indicating the magnitude of the back EMF” is referred to as the “effective back EMF value.” Back EMF can be generated by the nine coils. The effective back EMF value may indicate the magnitude of the back EMF generated by each (or any one) of the nine coils.

If the stator comprises the first coil group, the second coil group, and the third coil group delta-connected to each other as described below, and if each of the first to third coil groups includes three of the nine coils, then the effective back EMF value may indicate the magnitude of the back EMF of any of the first to third coil groups.

The brushless motor may comprise a first terminal, a second terminal, and a third terminal that are connected to the nine coils and are configured to supply electrical power (e.g., three-phase electrical power) to the nine coils. In this situation, the effective back EMF value may indicate the magnitude of the back EMF generated between any two of the first to third terminals. If the nine coils are delta-connected to each other, then the first terminal may be connected to a connection point (hereinafter referred to as the “first connection point”) between the first coil group and the second coil group, the second terminal may be connected to a connection point (hereinafter referred to as the “second connection point”) between the second coil group and the third coil group, and the third terminal may be connected to a connection point (hereinafter referred to as the “third connection point”) between the third coil group and the first coil group.

Back EMF may vary periodically (e.g., sinusoidally) in accordance with the rotational position (or rotational angle) of the rotor of the brushless motor. Every time the rotor rotates by a mechanical angle corresponding to an electrical angle of 360°, the back EMF varies over one period.

It is noted that the mechanical angle is the actual rotational angle of the rotor. The relationship between the electrical angle and the mechanical angle depends on the number of poles of the brushless motor. For example, if the brushless motor has two magnetic poles, then a mechanical angle of 1° corresponds to an electrical angle of 1°. If the brushless motor has twelve magnetic poles, then a mechanical angle of 1° corresponds to an electrical angle of 6°. In this situation, a rotor, which actually rotates 60°, is synonymous with a rotor rotating an electrical angle of 360°.

The effective back EMF value E indicates the magnitude (or substantially the magnitude) of the back EMF, which varies periodically as described above.

The effective back EMF value E may be determined in any manner. The effective back EMF value E may be, for example, the effective value of the back EMF or may be the average value of the absolute value of the back EMF. In addition, the effective back EMF value E may be, for example, the average value of the back EMF in a prescribed sector within one period of the electrical angle or may be the back EMF value (i.e., an instantaneous value) at a prescribed electrical angle. The prescribed sector may include, for example, an electrical angle ωem at which the back EMF reaches its maximum value. The electrical angle ωem may be the center of the prescribed sector. The width of the prescribed sector may be determined as appropriate, and may be, for example, 60°.

The back-EMF constant k may satisfy a condition different from 1.1≤k≤9.0. The back-EMF constant k may satisfy the condition of, for example, being equal to or greater than a first threshold and equal to or less than a second threshold. The first threshold may be less than 1.1 or may be greater than 1.1. The first threshold may be, for example, 1.13. The second threshold may be less than 9.0 or may be greater than 9.0. The back-EMF constant k may be, for example, 2.25 or more and 4.50 or less, 1.13 or more and 2.25 or less, or 4.50 or more and 9.0 or less.

Certain embodiments may have at least any one of the following features in addition to or instead of at least any one of Features 1-21 described above.
Feature 22: The brushless motor has a coefficient α (in mΩ/(V/krpm)²) that satisfies the condition 0.2≤α≤19.0.
Feature 23: The coefficient α is calculated using numerical formula R/k².
Feature 24: In the numerical formula of Feature 23, R (in mΩ) is a motor-resistance value based on the resistance value of at least one of the nine coils.
Feature 25: In the numerical formula of Feature 23, k (in V/krpm) is the back-EMF constant calculated using numerical formula E/N described above.

In an electric work machine having at least Features 1-17 and 22-25, it becomes possible to make the outer-rotor-type brushless motor installed in the electric work machine more compact. In addition, it may be possible to increase the brushless motor high output (i.e., to make it compact and high output).

The motor-resistance value may be a resistance value between two prescribed locations (nodes) in an electric circuit that includes the nine coils.

If the brushless motor comprises the first to third coil groups described above, then the motor-resistance value may be the resistance value between any two of the first to third connection points described above.

If the brushless motor comprises the first to third terminals described above, then the motor-resistance value may be the resistance value between any two of the first to third terminals.

The coefficient α may satisfy a condition different from 0.2≤α≤19.0. The coefficient α may satisfy the condition of, for example, being equal to or greater than a third threshold and equal to or less than a fourth threshold. The third threshold may be less than 0.2 or may be greater than 0.2. The third threshold may be, for example, 0.27, 0.4, or 0.54. The fourth threshold may be less than 19.0 or may be greater than 19.0. The fourth threshold may be, for example, 1.63, 6.08, or 18.96. Specifically, the coefficient α may satisfy, for example, the condition 0.4≤α≤19.0.

Certain embodiments may have at least any one of the following features in addition to or instead of at least any one of Features 1-25 described above.
Feature 26: The rotor core has a rotor-core outer diameter ør (in mm) that satisfies the condition 55≤ør≤80.
Feature 27: The rotor-core outer diameter er is the outer diameter of the rotor core. The rotor-core outer diameter er may be, in greater detail, the length of the rotor core in the radial direction (diametrical direction). The radial direction is orthogonal to the rotational axis of the rotor.

In an electric work machine having at least Features 1-17, 26, and 27, it becomes possible to make the outer-rotor-type brushless motor installed in the electric work machine more compact. In addition, it may be possible to increase the brushless motor high output (i.e., to make it compact and high output).

Certain embodiments may have at least any one of the following in addition to or instead of at least any one of Features 1-27 described above.
Feature 28: The stator core has a stator-core outer diameter øs (in mm) that satisfies the condition 40≤øs≤72.5.
Feature 29: The stator-core outer diameter øs is the outer diameter of the stator core. The stator-core outer diameter øs may be, in greater detail, the length of the stator core in the radial direction (diametrical direction).

In an electric work machine having at least Features 1-17, 28, and 29, it becomes possible to make the outer-rotor-type brushless motor installed in the electric work machine more compact. In addition, it may be possible to increase the brushless motor high output (i.e., to make it compact and high output).

Certain embodiments may have at least any one of the following features in addition to or instead of at least any one of Features 1-29 described above.
Feature 30: The brushless motor has a rotor-flatness ratio ηr that satisfies the condition 0.1≤ηr≤0.7.
Feature 31: The rotor-flatness ratio ηr is calculated using numerical formula Ds/ør. Feature 32: In the numerical formula of Feature 31, Ds (in mm) is the length of the stator core in an axial direction, the axial direction being parallel to the rotational axis of the rotor.
Feature 33: In the numerical formula of Feature 31, ør (in mm) is the rotor-core outer diameter.

In an electric work machine having at least Features 1-17 and 30-33, it becomes possible to make the outer-rotor-type brushless motor installed in the electric work machine more compact. In addition, it may be possible to increase the brushless motor high output (i.e., to make it compact and high output).

Certain embodiments may have at least any one of the following features in addition to or instead of at least any one of Features 1-33 described above.
Feature 34: The brushless motor has a stator-flatness ratio ηs that satisfies the condition 0.1≤ηs≤0.8.
Feature 35: The stator-flatness ratio ηs is calculated using numerical formula Ds/øs.
Feature 36: In the numerical formula of Feature 35, Ds (in mm) is the length of the stator core in the axial direction as described above.
Feature 37: In the numerical formula of Feature 35, øs (in mm) is the stator-core outer diameter.

In an electric work machine having at least Features 1-17 and 34-37, it becomes possible to make the outer-rotor-type brushless motor installed in the electric work machine more compact. In addition, it may be possible to increase the brushless motor high output (i.e., to make it compact and high output).

Certain embodiments may have at least any one of the following features in addition to or instead of at least any one of Features 1-37 described above.
Feature 38: The brushless motor has a rotor-flatness-ratio density ξr (in kW⁻¹) that satisfies the condition fr2≤ξr≤fr1.
Feature 39: The rotor-flatness-ratio density ξr is calculated using numerical formula ηr/P.
Feature 40: In the numerical formula of Feature 39, ηr is calculated using numerical formula Ds/ør.
Feature 41: In the numerical formula of Feature 40, Ds (in mm) is the length of the stator core in the axial direction as described above.
Feature 42: In the numerical formula of Feature 40, ør (in mm) is the rotor-core outer diameter described above.
Feature 43: In the numerical formula of Feature 39, P (in kW) is the output of the brushless motor.
Feature 44: fr1 satisfies the following equation.

$$fr 1 = 0.000465 ∅ {r}^{2} - 0.0782 ∅ r + 3.43$$

Feature 45: fr2 satisfies the following equation.

$$fr 2 = 0.000443 ∅ {r}^{2} - 0.0698 ∅ r + 2.79$$

Feature 46: The rotor-core outer diameter er (in mm) satisfies 55≤ør≤80.

In an electric work machine having at least Features 1-17 and 38-46, it becomes possible to make the outer-rotor-type brushless motor installed in the electric work machine more compact. In addition, it may be possible to increase the brushless motor high output (i.e., to make it compact and high output).

Output P may be the output when the rotor is rotating at a prescribed rotational speed. The prescribed rotational speed may be a rated rotational speed, may be an unloaded rotational speed when a load is not being applied to the electric work machine from outside of the electric work machine, or may be a theoretical unloaded rotational speed (i.e., of the brushless motor alone) when a load is not being applied to the rotor itself.

The prescribed rotational speed may be, for example, 14,000 rpm or may be 12,000 rpm.

The output P may be, for example, a prescribed value of 1.0 kW or more and 2.4 kW or less. The output P may be, for example, a prescribed value of 1.5 kW or more and 2.4 kW or less. The output P may be, for example, 1.5 kW.

Certain embodiments may have at least any one of the following features in addition to or instead of at least any one of Features 1-46 described above.
Feature 47: The brushless motor has a stator-flatness-ratio density ξs (in kW⁻¹) that satisfies the condition fs2≤ξs≤fs1.
Feature 48: The stator-flatness-ratio density ξs is calculated using numerical formula ηs/P.
Feature 49: In the numerical formula of Feature 48, ηs is calculated using numerical formula Ds/øs.
Feature 50: In the numerical formula of Feature 49, Ds (in mm) is the length of the stator core in the axial direction as described above.
Feature 51: In the numerical formula of Feature 49, øs (in mm) is the stator-core outer diameter as described above.
Feature 52: In the numerical formula of Feature 48, P (in kW) is the output of the brushless motor as described above.
Feature 53: fs1 satisfies the following equation.

$$fs 1 = 0.00105 ∅ {s}^{2} - 0.144 ∅ s + 5.13$$

Feature 54: fs2 satisfies the following equation.

$$fs 2 = 0.000665 ∅ {s}^{2} - 0.0887 ∅ s + 3.$$

Feature 55: The stator-core outer diameter øs (in mm) satisfies 45≤øs≤70.

In an electric work machine having at least Features 1-17 and 47-55, it becomes possible to make the outer-rotor-type brushless motor installed in the electric work machine more compact. In addition, it may be possible to increase the brushless motor high output (i.e., to make it compact and high output).

Certain embodiments may have at least any one of the following features in addition to or instead of at least any one of Features 1-55 described above.
Feature 56: The rotor core comprises twelve magnet parts.
Feature 57: The twelve magnet parts are disposed spaced apart from each other along (around) the rotational direction of the rotor core.
Feature 58: Each of the twelve magnet parts comprises one or more permanent magnets.
Feature 59: Each of the twelve magnet parts forms a corresponding one of the twelve magnetic poles.

In an electric work machine having at least Features 1-17 and 56-59, the twelve magnetic poles can easily be realized.

The twelve magnet parts may be completely embedded within the rotor core or may be fixed on the inner-circumferential surface of the rotor core so as to be exposed to the stator side, as described below.

Certain embodiments may have the following features in addition to or instead of at least any one of Features 1-59 described above.
Feature 60: The one or more permanent magnets include a sintered magnet containing neodymium, iron, and boron.

In an electric work machine having at least Features 1-17 and 56-60, a magnetic force of suitable (or necessary and sufficient) magnitude can be generated from the one or more permanent magnets while curtailing increases in the size of the one or more permanent magnets.

Each of the one or more permanent magnets (hereinafter, simply “the permanent magnets”) may be a so-called Nd—Fe—B magnet. Nd—Fe—B magnets are primarily composed of neodymium (Nd), iron (Fe), and boron (B).

In another embodiment, the permanent magnets may be Fe—N magnets. Fe—N magnets are primarily composed of iron (Fe) and nitrogen (N).

In another embodiment, the permanent magnets may be Sm—Fe—N magnets. Sm—Fe—N magnets are primarily composed of samarium (Sm), iron (Fe), and nitrogen (N).

In another embodiment, the permanent magnets may be Sm—Fe magnets. Sm—Fe magnets are primarily composed of samarium (Sm) and iron (Fe).

In another embodiment, the permanent magnets may be sintered magnets or may be magnets different from sintered magnets (e.g., bonded magnets).

Certain embodiments may have at least any one of the following features in addition to or instead of at least any one of Features 1-60 described above.
Feature 61: The twelve magnet parts are mounted on the inner-circumferential surface of the rotor core.

Feature 61 may mean that the brushless motor is a so-called SPM-type motor. “SPM” is an abbreviation for “Surface Permanent Magnet.”

In an electric work machine having at least Features 1-17, 56-59, and 61, the twelve magnet parts can be easily mounted on the rotor core.

Certain embodiments may have the following features in addition to or instead of at least any one of Features 1-61 described above.
Feature 62: Each of the twelve magnet parts includes two or more permanent magnets that are independent of each other.

In an electric work machine having at least Features 1-17, 56-59, and 62, it becomes possible to reduce eddy currents generated in the magnet parts (and, in turn, to reduce eddy-current losses in the magnet parts).

Certain embodiments may have the following feature in addition to or instead of at least any one of Features 1-62 described above.
Feature 63: In each of the twelve magnet parts, the two or more permanent magnets are disposed along the circumferential direction of the rotor core.

In an electric work machine having at least Features 1-17, 56-59, 62, and 63, eddy currents generated in the magnet parts can easily be reduced.

Certain embodiments may have the following in addition to or instead of at least any one of features 1-63 described above.
Feature 64: In each of the twelve magnet parts, the two or more permanent magnets are disposed along the rotational axis of the rotor core.

In an electric work machine having at least Features 1-17, 56-59, 62, and 64, eddy currents generated in the magnet parts can easily be reduced.

Each of the first to third coil groups may have a first end and a second end. The first end of the first coil group may be connected to the second end of the third coil group, the second end of the first coil group may be connected to the first end of the second coil group, and the second end of the second coil group may be connected to the first end of the third coil group.

Certain embodiments may have the following feature in addition to or instead of at least any one of Features 1-64 described above.
Feature 65: The nine coils are delta-connected.

In an electric work machine having at least Features 1-17 and 65, the output of the brushless motor can be increased while curtailing thickening of the coils.

Certain embodiments may have at least any one of the following features in addition to or instead of at least any one of Features 1-65 described above.
Feature 66: The stator comprises a first coil group, a second coil group, and a third coil group, which are delta-connected.
Feature 67: The first coil group includes three of the nine coils, the three coils being connected in parallel to each other.
Feature 68: The second coil group includes three of the nine coils, the three coils being different from those of the first coil group and connected in parallel to each other.
Feature 69: The third coil group includes three of the nine coils, the three coils being different from those of the first coil group and the second coil group and connected in parallel to each other.

In an electric work machine having at least Features 1-17 and 65-69, the output of the brushless motor can be increased while curtailing thickening of the coils.

Certain embodiments may have at least any one of the following features in addition to or instead of at least any one of Features 1-69 described above.
Feature 70: The stator core has a slot-opening width Wso (in mm) that satisfies the condition 0.04 øs≤Wso≤0.18 øs.
Feature 71: The slot-opening width Wso is the straight-line distance, along the circumferential direction of the radially outward opening, between any two teeth, of the nine teeth, that are adjacent in the circumferential direction.

The stator core may have nine openings. Slot-opening width Wso may be equal for each of the nine openings.

In an electric work machine having at least features 1-17, 70, and 71, it becomes possible to make the brushless motor more compact while maintaining the work efficiency of winding the coils around the teeth.

The slot-opening width Wso may be rephrased as the straight-line distance along the circumferential direction of the radially outward opening of each of the nine slots.

Each of the nine teeth may have a main-body portion extending radially outward from the back core and a flange-shaped tip portion provided at the end portion of the main-body portion. In such an embodiment, the distance between two of the tip portions that are adjacent in the circumferential direction may be defined as the slot-opening width Wso.

Certain embodiments may have at least any one of the following features in addition to or instead of at least any one of Features 1-71 described above.
Feature 72: The electric work machine is provided with a grip portion.
Feature 73: The grip portion is configured to be gripped by the user of the electric work machine.
Feature 74: The electric work machine comprises a battery-mounting part.
Feature 75: The battery-mounting part is configured such that the battery pack is mounted thereon in a detachable manner.
Feature 76: The battery pack comprises a battery (i.e. one or more battery cells).

In an electric work machine having at least Features 1-17 and 72-76, it becomes possible to make the battery-driven electric work machine comprising an outer-rotor-type brushless motor more compact.

Examples of the electric work machine described above include various types of apparatuses configured for use at work sites in fields such as construction, manufacturing, landscaping, civil engineering, etc.; specific examples include: power tools for masonry, metalworking, and carpentry; power tools for gardening; power tools for setting up work site environments; fan vests; fan jackets; hand trucks; electric-power assisted bicycles; air pumps; and the like.

Examples of the power tools described above include electric chain saws, electric hand saws, electric blowers, electric hammers, electric hammer drills, electric drills, electric screwdrivers, electric wrenches, electric impact drivers, electric impact wrenches, electric grinders, electric circular saws, electric reciprocating saws, electric jigsaws, electric cutters, electric planers, electric nailers (including tackers), electric hedge trimmers, electric lawn mowers, electric lawn edgers, electric brush cutters, electric cleaners, electric sprayers, electric spreaders, electric dust collectors, electric trowels, electric vibrators, electric rammers, electric compactors, electric pumps, electric pile drivers, electric concrete saws, electric screeds, electric cut-off saws, electric fans, and the like.

Examples of the tool accessory include: saw chains for electric chain saws; screwdriver bits, drill bits, and socket bits for electric screwdrivers, electric drills, and electric wrenches; saw blades for electric circular saws; cutting blades for electric brush cutters; blades for electric fans; and the like.

The examples of electric work machines described above may be in the form of battery-driven devices having built-in batteries or battery-driven devices having a battery mounting part for detachably mounting a rechargeable battery pack.

In certain embodiments, the above-mentioned Features 1-76 may be combined in any manner.

In certain embodiments, any of the above-mentioned Features 1-76 may be excluded.

### 2. Specific Illustrative Embodiments

Specific exemplary embodiments will be described below. These specific exemplary embodiments provide an electric work machine 1 in the form of an electric chain saw. However, such an electric work machine 1 is merely one example, and the present disclosure can be applied to all forms of electric work machines that utilize a brushless motor, as was mentioned above.

### 2-1. First Embodiment

### 2-1-1. Overall Configuration of Electric Work Machine

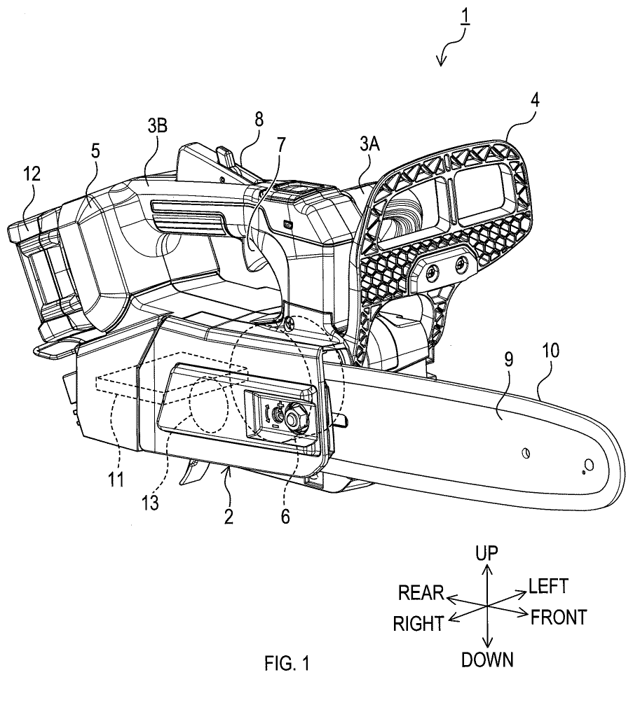

As shown in FIG. 1, the electric work machine 1 comprises a housing (or casing) 2. The housing 2 is formed of a synthetic resin. A motor 6 is housed in the interior of the housing 2. A controller 11 is housed in the interior of the housing 2.

It is noted that, in the present embodiments, for convenience of explanation, directions “up,” “down,” “right,” “left,” “front,” and “rear” centered on the electric work machine 1 are defined, as shown in FIG. 1 onward.

The electric work machine 1 comprises a guide bar 9. The guide bar 9 is a plate-shaped member. The guide bar 9 protrudes from the housing 2 in the forward direction of the electric work machine 1.

The electric work machine 1 comprises a saw chain 10. The saw chain 10 includes a plurality of cutters coupled to each other. The saw chain 10 is mounted on a circumferential-edge portion of the guide bar 9 in a detachable manner. The saw chain 10 corresponds to one example of a tool accessory in the summary of the embodiments.

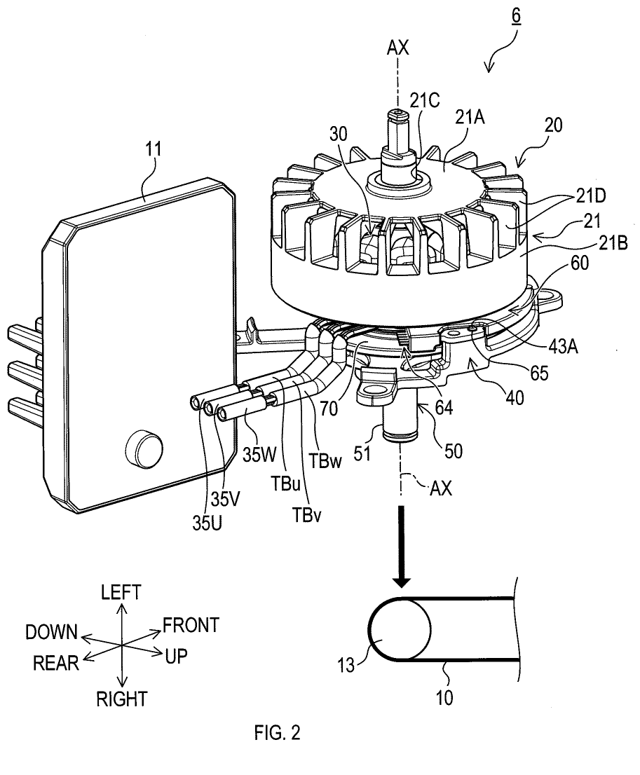

The electric work machine 1 comprises a motive-power-transmitting part (transmission) 13. The motive-power-transmitting part 13 is directly or indirectly coupled to a rotor shaft 50 (refer to FIG. 2) of the motor 6. The saw chain 10 is operably coupled to the motor 6 via the motive-power-transmitting part 13. The motive-power-transmitting part 13 includes a sprocket (not shown) configured for the saw chain 10 to be mounted thereon. The motive-power-transmitting part 13 transmits the rotational energy output by the motor 6 (i.e., the rotation of the rotor shaft 50) to the saw chain 10, thereby driving the saw chain 10.

Accordingly, by driving the motor 6, the saw chain 10 moves around (along) the circumferential-edge portion of the guide bar 9. The electric work machine 1 is capable of cutting a workpiece using the moving saw chain 10.

The electric work machine 1 comprises a battery-mounting part 5. The battery-mounting part 5 in the present embodiment protrudes upward from a rear portion of the housing 2. A battery pack 12 is mounted on the battery-mounting part 5 in a detachable manner. The battery pack 12 can be mounted on a rear-portion end surface of the battery-mounting part 5.

The battery pack 12 includes a battery, i.e. one or more battery cells. The battery is (battery cells are) in the form of one or more rechargeable (secondary) batteries. The battery (cells) may be, for example, one or more lithium-ion secondary battery cells or one or more solid-state battery cells. However, in some embodiments of the present teachings, the battery may instead be a non-rechargeable primary battery. The rated voltage of the battery (battery pack) in the present embodiment is 36 V. However, the rated voltage of the battery (battery pack) may differ from 36 V, and may generally be any rated voltage in the range of 10-100 V, e.g., 14-75 V.

When mounted on the battery-mounting part 5, the battery pack 12 is capable of supplying battery power (current) to the electric work machine 1. Battery power (current) is output from the battery. The motor 6 receives battery power (current) from the battery pack 12 via the controller 11 and is driven thereby.

The electric work machine 1 comprises a handguard 4. The handguard 4 protrudes upward from a front portion of the housing 2.

The electric work machine 1 comprises a side handle 3A and a top handle 3B, which are rearward of the handguard 4. One of the side handle 3A and the top handle 3B may be omitted. The side handle 3A and the top handle 3B are formed of a polymer (synthetic resin).

The side handle 3A is a pipe-shaped member. The side handle 3A protrudes leftward from a left portion of the housing 2. Accordingly, the user of the electric work machine 1 is capable of gripping the side handle 3A with the user's left hand from rearward of the electric work machine 1.

The top handle 3B protrudes upward from an upper portion of the housing 2. The rear end of the top handle 3B is connected to the battery-mounting part 5, whereby a space is formed between the top handle 3B and the housing 2. Consequently, the user is capable of inserting the user's fingers into this space to grip the top handle 3B.

The electric work machine 1 comprises a trigger switch 7 downward of the top handle 3B. The trigger switch 7 is manipulated (for example, pulled) by the user to drive the motor 6. When the trigger switch 7 is pulled upward by the user, the motor 6 is driven. In addition, when the manipulation of the trigger switch 7 is released, the driving of the motor 6 is stopped.

The electric work machine 1 comprises a trigger-lock lever 8 upward of the top handle 3B. When the user pushes the trigger-lock lever 8 downward, manipulation of the trigger switch 7 is permitted.

A specific configuration of the motor 6 is described below, with reference to FIG. 2 to FIG. 8.

### 2-1-2. Specific Configuration of Motor

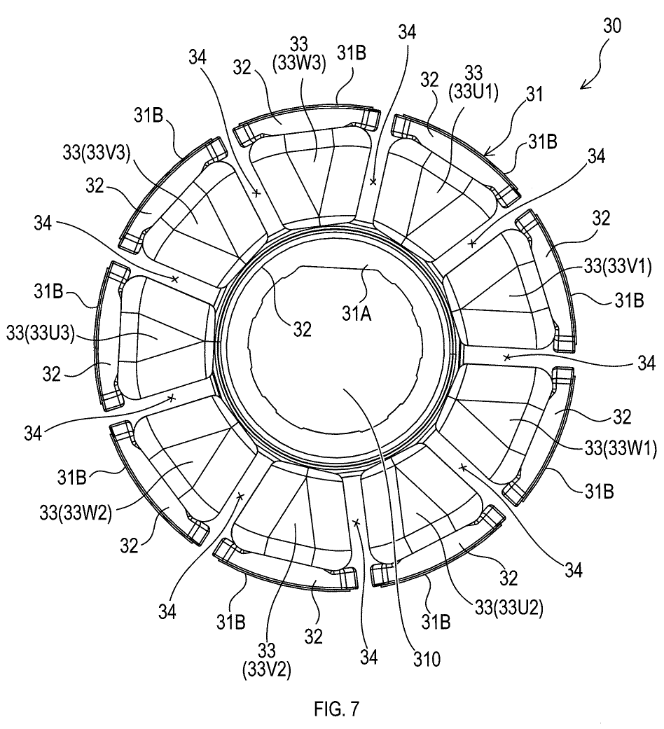

In the present embodiment, the motor 6 is in the form of an outer-rotor-type brushless motor. More specifically, the motor 6 of the present embodiment is a 12-pole, 9-slot brushless motor. That is, the motor 6 has twelve magnetic poles and nine slots 34 (see FIG. 7).

As shown in FIG. 2 to FIG. 6 and FIG. 8, the motor 6 comprises a rotor 20 and a stator 30.

The rotor 20 is disposed on the outer-circumference side of the stator 30 and rotates around the stator 30.

The motor 6 also comprises the rotor shaft 50. The rotor shaft 50 is fixed to the rotor 20. The central axis of the rotor shaft 50 coincides with rotational axis AX of the motor 6. Accordingly, the rotor 20 and the rotor shaft 50 rotate about rotational axis AX.

The motor 6 comprises a sensor board 60. The sensor board 60 comprises three magnetic sensors 62A, 62B, 62C, which detect the rotation (more specifically, the rotational position) of the rotor 20.

The motor 6 comprises a stator base 40. The stator base 40 supports the stator 30 and the sensor board 60.

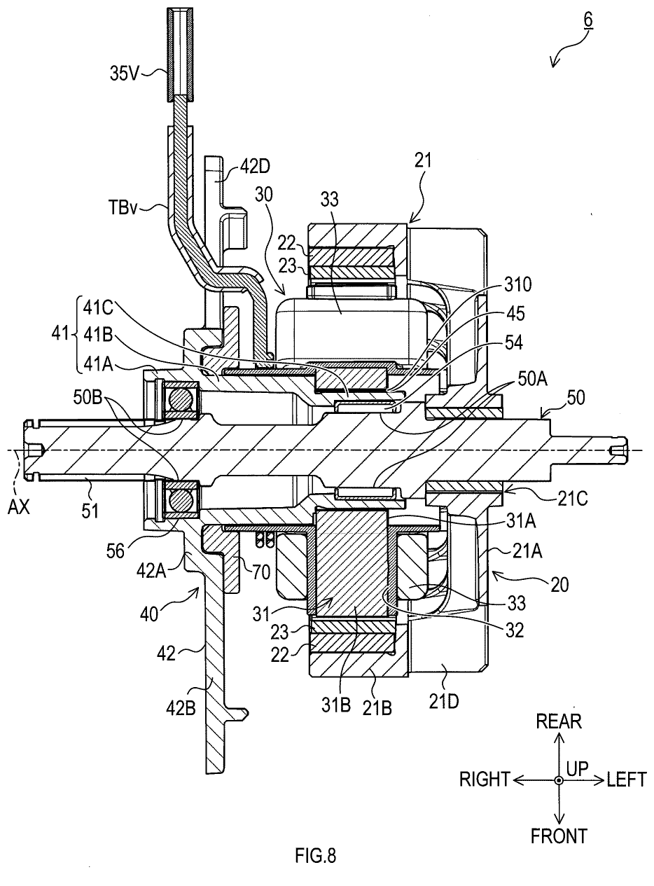

The motor 6 comprises an insulating member 70. The insulating member 70 is disposed between the stator base 40 and the stator 30. The insulating member 70 has the shape of a hollow disc. A second support portion 41B (described below) is inserted through an inner hole in the insulating member 70 (see FIG. 8).

The rotor shaft 50 passes through the stator 30, the insulating member 70, and the stator base 40 and protrudes from the rotor 20 to the exterior. The rotor shaft 50 comprises an output shaft 51. The output shaft 51 corresponds to a portion of the rotor shaft 50 that includes a first end protruding from the stator base 40 to the exterior. The output shaft 51 is directly or indirectly coupled to the motive-power-transmitting part 13. The rotor shaft 50 drives the saw chain 10 via the motive-power-transmitting part 13.

The principal components of the motor 6, including the rotor 20, the stator 30, and the stator base 40, are described below in more detail with reference to FIG. 2 to FIG. 8.

2-1-2a. Rotor

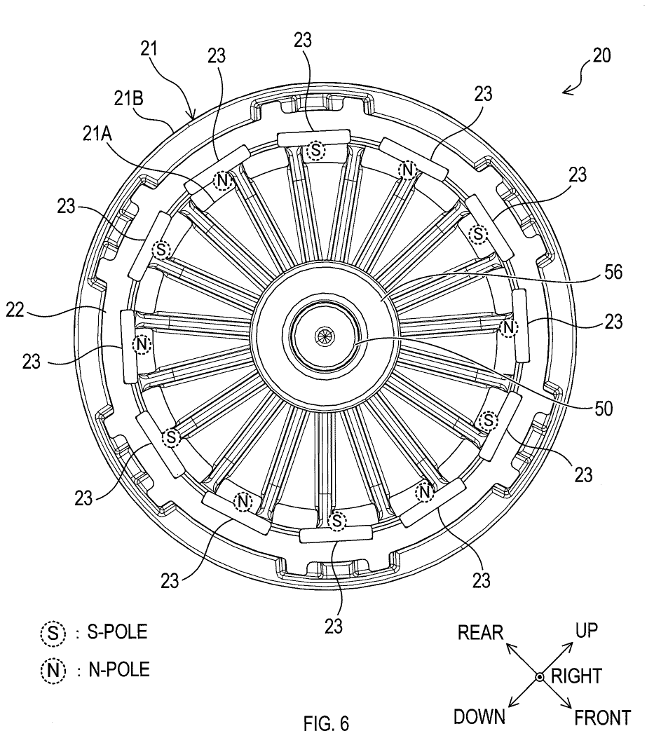

As shown in FIG. 2, FIG. 6, and FIG. 8, the rotor 20 comprises a rotor cup 21. The rotor cup 21 is made of metal. Specifically, the rotor cup 21 contains aluminum (e.g., it is made of an aluminum alloy), which is a nonmagnetic material, as the main (majority) component.

The rotor cup 21 comprises a plate portion 21A. The plate portion 21A has a circular-ring shape. The plate portion 21A has an opening 21C in the center portion thereof. The rotor shaft 50 is inserted through the opening 21C, thereby fixing the rotor shaft 50. The rotor shaft 50 may be fixed to the rotor cup 21 by any method. In the present embodiment, the rotor shaft 50 is press-fitted into the opening 21C and thereby fixed to the opening 21C (and, in turn, to the rotor cup 21).

The rotor cup 21 comprises a yoke portion 21B. The yoke portion 21B has a circular-tube shape. The yoke portion 21B encircles the rotor shaft 50.

The rotor cup 21 comprises a plurality of fins 21D between the plate portion 21A and the yoke portion 21B. The yoke portion 21B is connected to the outer-circumferential edge of the plate portion 21A via the plurality of fins 21D. The fins 21D are disposed equispaced along the outer circumference of the plate portion 21A. The fins 21D rotate together with the plate portion 21A (in other words, the rotor 20), thereby generating a draft. The draft cools the motor 6.

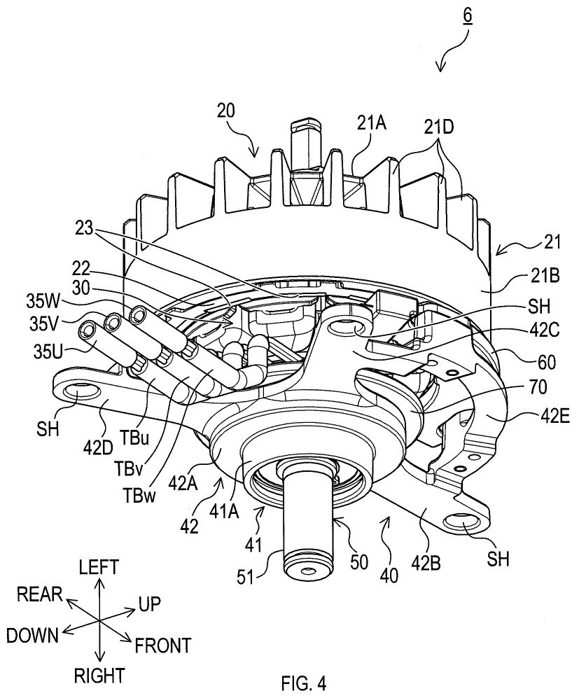

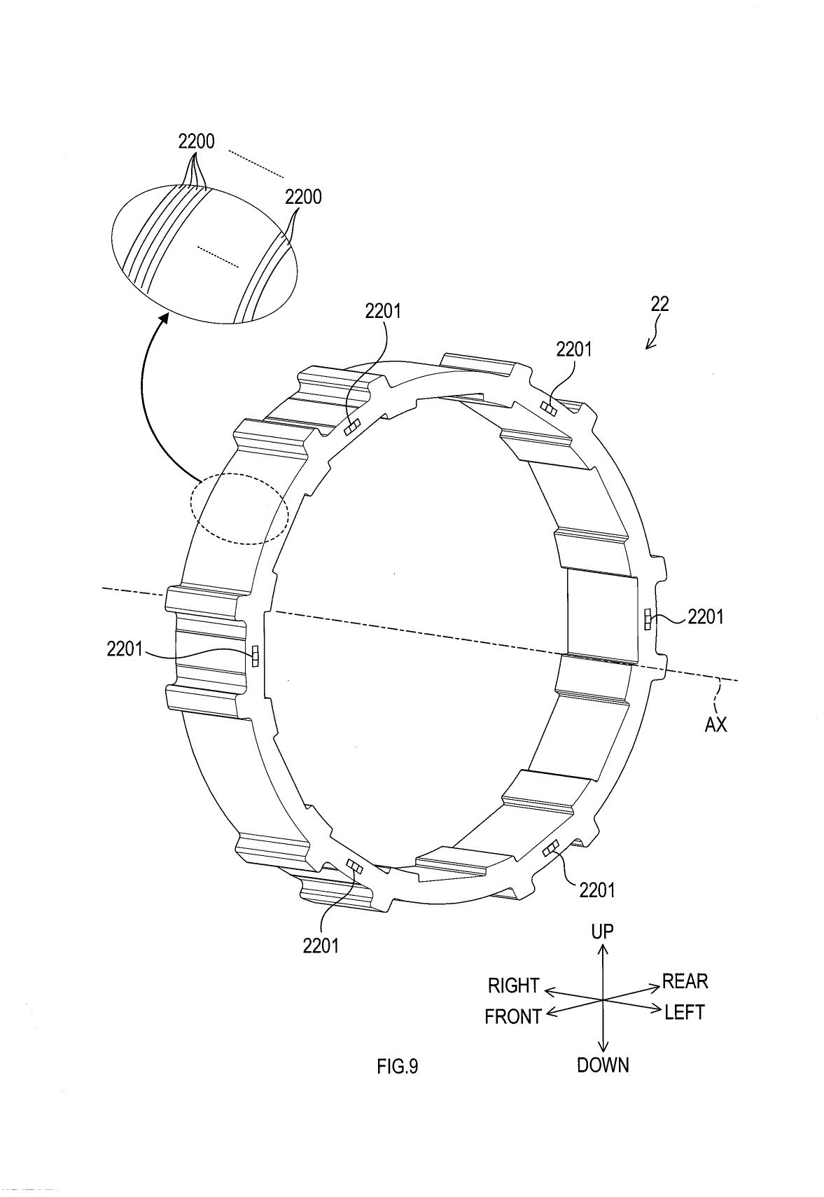

As shown in FIG. 4 to FIG. 6, FIG. 8, and FIG. 9, the rotor 20 comprises a rotor core 22. As shown in the partial, enlarged view in FIG. 9, the rotor core 22 comprises a plurality of first core sheets 2200 laminated in the direction along rotational axis AX (hereinafter referred to as “the axial direction”). The rotor core 22 has a substantially circular-tube shape. As shown in FIG. 4 to FIG. 6 and FIG. 8, the rotor core 22 is supported on an inner-circumferential surface of the yoke portion 21B of the rotor cup 21.

Each of the first core sheets 2200 has a sheet shape and contains a soft magnetic material. Each of the first core sheets 2200 is, for example, an electrical steel sheet. The rotor core 22 is in the form of a laminated body in which the first core sheets 2200 are laminated.

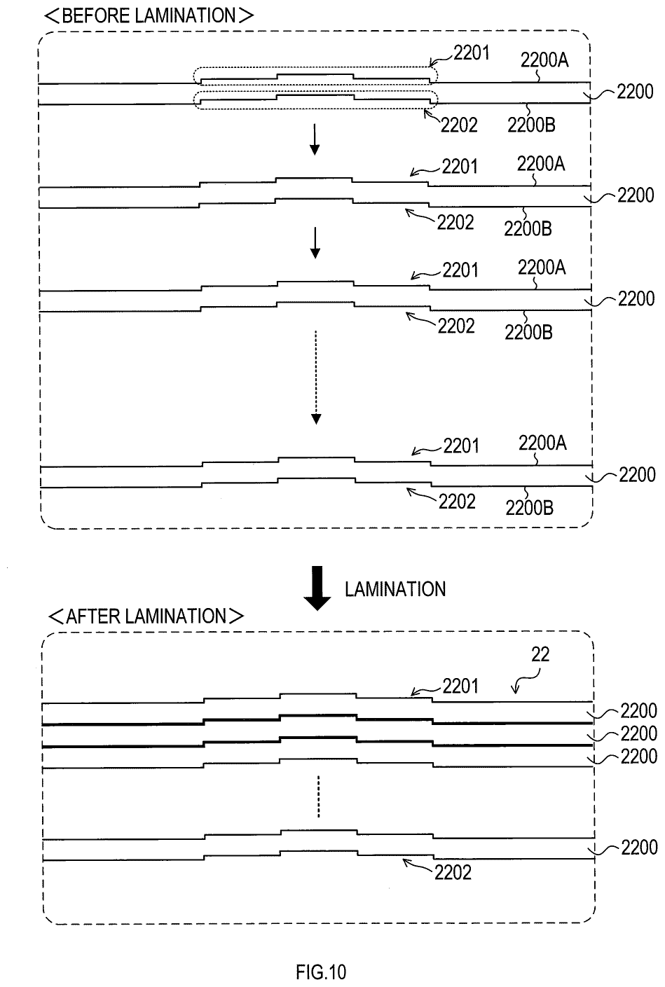

The lamination configuration of the rotor core 22 will be described in more detail, with reference to FIG. 10. Each of the first core sheets 2200 has a first surface 2200A and a second surface 2200B.

A protruding portion 2201 is formed on each of the first surfaces 2200A. It is noted that the protruding portions 2201 are also shown in FIG. 9. A recessed portion 2202 is formed on each of the second surfaces 2200B. The recessed portions 2202 are provided at locations on the second surfaces 2200B overlapping the protruding portions 2201 in the axial direction.

In the process in which the first core sheets 2200 are laminated, the protruding portion 2201 of one of two opposing first core sheets 2200 is fitted into the recessed portion 2202 of the other of the two opposing first core sheets 2200. The rotor core 22 (i.e., the lamination), in which the first core sheets 2200 are laminated in tight contact with each other in the axial direction, is thereby formed, as shown in FIG. 10.

When the protruding portions 2201 are fitted into the recessed portions 2202, the protruding portions 2201 no longer (or tend not to) come out of the recessed portions 2202 owing to the interacting pressure (and/or frictional force) between the protruding portions 2201 and the recessed portions 2202.

In the present embodiment, when the protruding portions 2201 are fitted into the recessed portions 2202, the protruding portions 2201 and/or the recessed portions 2202 are mechanically deformed (elastically deformed or plastically deformed) by the pressure to which they are subjected when being fitted together. Owing to this mechanical deformation, the protruding portions 2201 are press-fitted into the recessed portions 2202, whereby the protruding portions 2201 no longer (or tend not to) come out of the recessed portions 2202.

It is noted that the first core sheets 2200 may be fixed to (i.e., integrated with) each other by any method. For example, they may be fixed to each other by another method instead of or in addition to the above-mentioned press-fitting. Other methods may include, for example, adhesive fixation using an adhesive, and laser welding.

As shown in detail in FIG. 6, the rotor 20 has twelve magnetic poles. In FIG. 6, the letter “S” surrounded by a broken-line circle indicates an S-pole magnetic pole, and the letter “N” surrounded by a broken-line circle indicates an N-pole magnetic pole. The twelve magnetic poles are disposed equispaced (or substantially equispaced) along the circumferential direction. Each of the twelve magnetic poles is oriented toward rotational axis AX.

To form the twelve magnetic poles, the rotor 20 of the present embodiment is provided with twelve magnets 23. It is noted that references simply to “magnet 23” in the following description refers to each of the twelve magnets 23 unless otherwise noted.

The magnets 23 are permanent magnets. Each of the magnets 23 has a sheet shape. In the present embodiment, the magnets 23 are in the form of sintered magnets. In the present embodiment, the magnets 23 are Nd—Fe—B magnets. However, the magnets 23 may be magnets other than Nd—Fe—B magnets. The magnets 23 may be, for example, Fe—N magnets, Sm—Fe—N magnets, or Sm—Fe magnets. The magnets 23 may be in a form other than sintered magnets (for example, bonded magnets).

The twelve magnets 23 are disposed spaced apart from each other along the circumferential direction on the inner-circumferential surface of the rotor core 22. Each of the magnets 23 is fixed on the inner-circumferential surface of the rotor core 22, for example, by an adhesive.

As shown in FIG. 6, each of the magnets 23 is disposed such that its two magnetic poles (the N-pole and the S-pole) are aligned along the radial direction. The radial direction is the direction perpendicular to rotational axis AX. That is, each of the magnets 23 is disposed such that one of the magnetic poles thereof is oriented (faces) toward rotational axis AX and the other is oriented (faces) in the direction opposite rotational axis AX. The twelve magnets 23 are disposed such that the N-poles and the S-poles thereof are alternately oriented toward rotational axis AX along the circumferential direction.

2-1-2b. Stator

The stator 30 is disposed on the inner-circumferential side of the rotor core 22; i.e. the stator 30 is disposed within the rotor core 22. That is, the stator 30 is disposed so as to oppose the twelve magnets 23 in the radial direction.

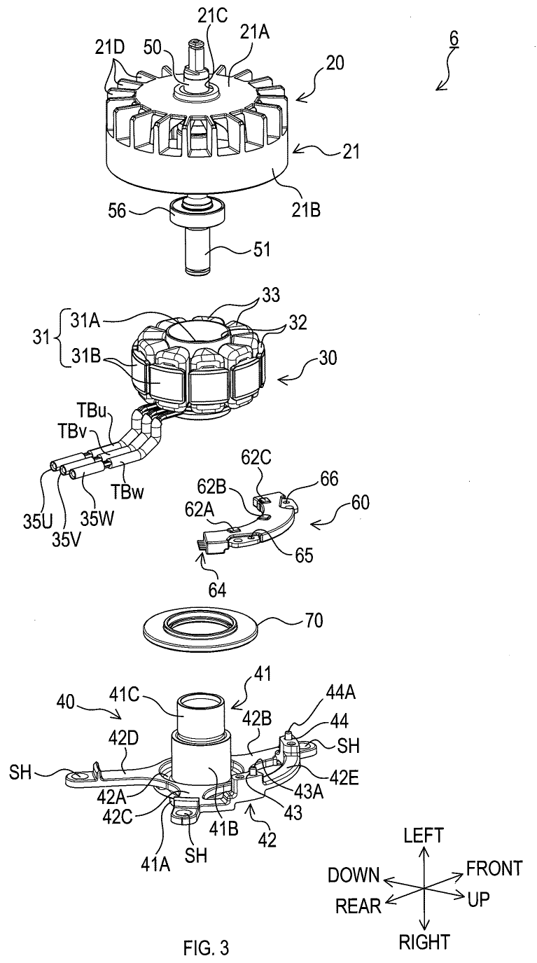

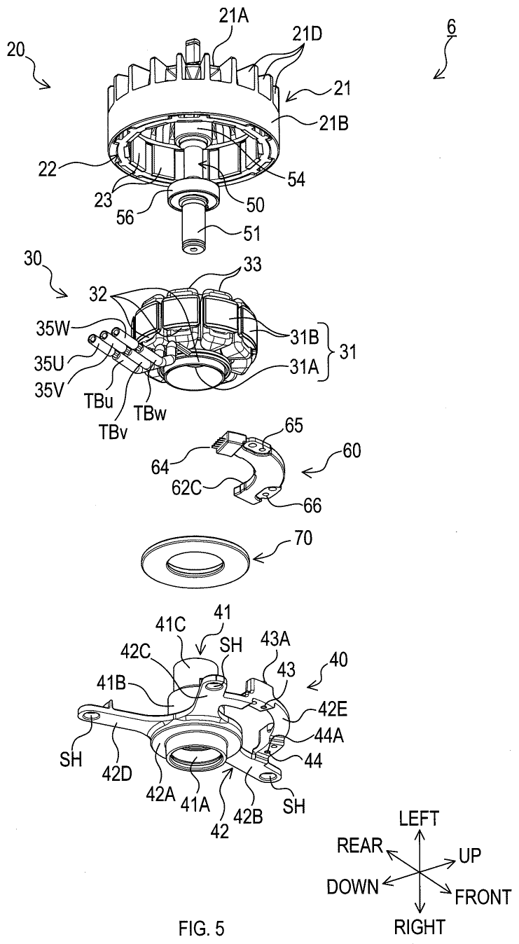

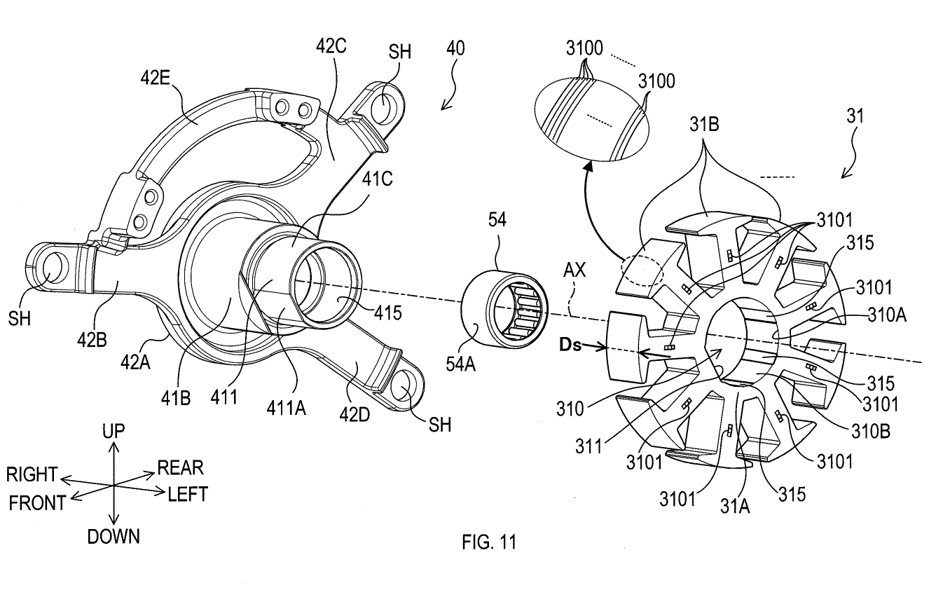

As shown in FIG. 3, FIG. 5, FIG. 7, and FIG. 8, the stator 30 comprises a stator core 31. The stator core 31 is formed of electrical steel. The stator core 31 comprises a plurality of second core sheets 3100, as shown in detail in the simplified enlarged view in FIG. 11. Each of the second core sheets 3100 has a sheet shape and contains a soft magnetic material. Each of the second core sheets 3100 is, for example, an electrical steel sheet. The second core sheets 3100 are laminated to each other along the axial direction. That is, the stator core 31 is in the form of a laminated body, in which the second core sheets 3100 are laminated.

The stator core 31 is formed in the same manner as the rotor core 22, i.e., by a process similar to the process shown in FIG. 10.

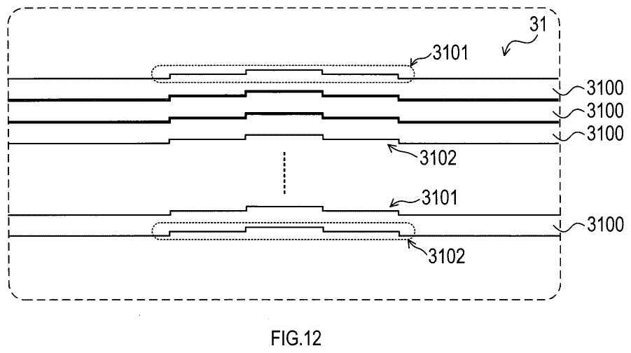

That is, in each of the second core sheets 3100, a protruding portion 3101 is formed on a first surface thereof, and a recessed portion 3102 is formed on a second surface thereof, as shown in FIG. 12. It is noted that the protruding portions 3101 are also shown in FIG. 11. The recessed portions 3102 are provided at locations overlapping the protruding portions 3101 in the axial direction.

In the process in which the second core sheets 3100 are laminated, the protruding portion 3101 of one of two opposing second core sheets 3100 is fitted into the recessed portion 3102 of the other of the two opposing second core sheets 3100. The stator core 31 (i.e., the lamination), in which the second core sheets 3100 are laminated in tight contact with each other in the axial direction, is thereby formed, as shown in FIG. 12.

In addition, as with the rotor core 22, when the protruding portions 3101 are fitted into the recessed portions 3102, the protruding portions 3101 are press-fitted to the recessed portions 3102, whereby the protruding portions 3101 no longer (or tend not to) come out of the recessed portions 3102. It is noted that the second core sheets 3100 may be fixed to (i.e., integrated with) each other by any method. For example, they may be fixed to each other by another method instead of or in addition to the above-mentioned press-fitting. Other methods may include, for example, adhesive fixation using an adhesive, and laser welding.

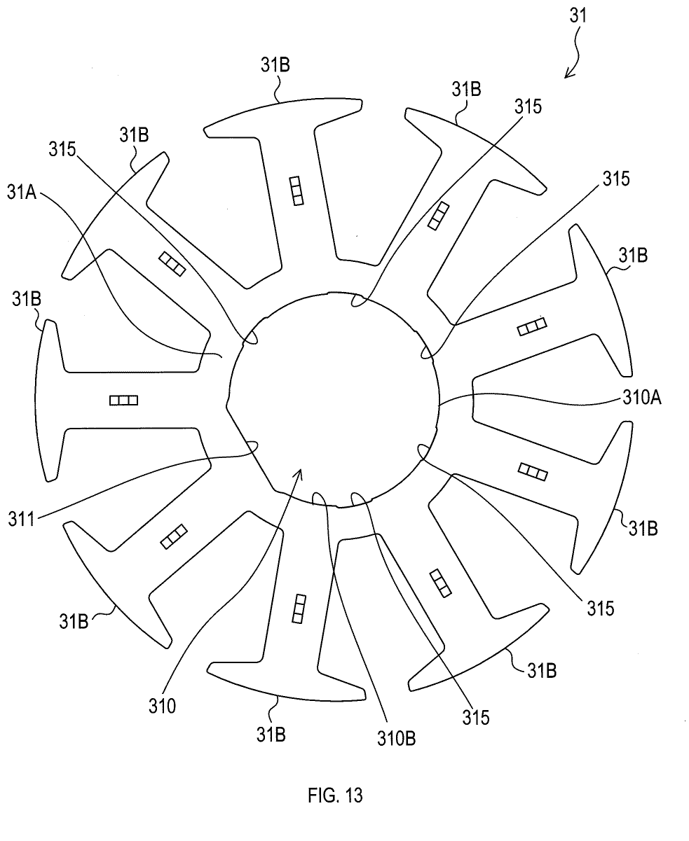

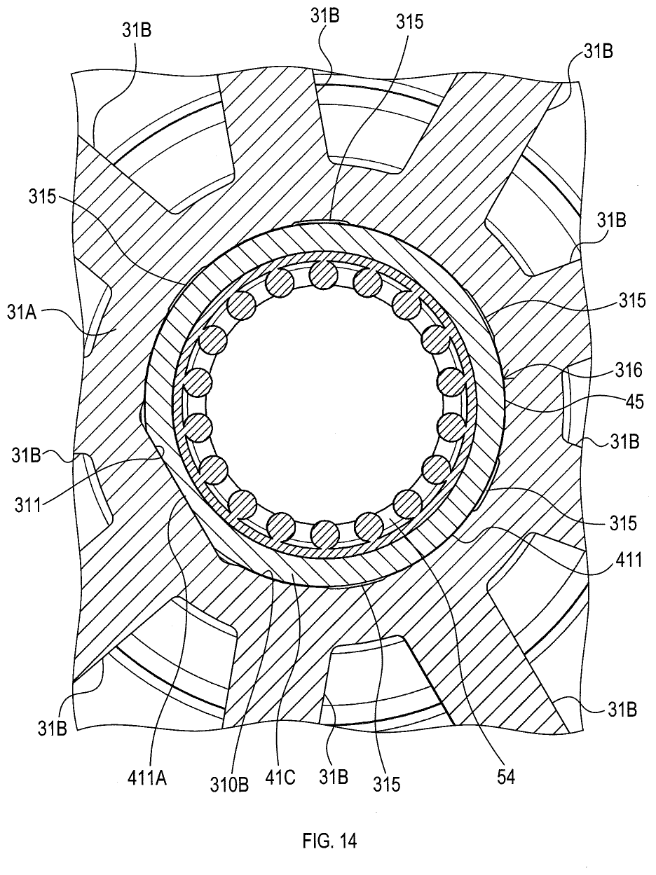

The stator core 31 comprises a yoke (or stator back) 31A. The yoke 31A has a tube shape. Specifically, the yoke 31A has a through hole 310, as shown in FIG. 7 and FIG. 8. The stator base 40 is inserted into the through hole 310, and the rotor shaft 50 is inserted into the stator base 40. That is, the rotor shaft 50 passes through the through hole 310 with the stator base 40 interposed therebetween. The central axis of the yoke 31A (i.e., the central axis of the through hole 310) coincides with rotational axis AX. The through hole 310 will be described in more detail below, with reference to FIG. 11, FIG. 13, and FIG. 14.

The stator core 31 comprises nine teeth 31B. The nine teeth 31B protrude radially outward from an outer-circumferential surface of the yoke 31A. The nine teeth 31B are disposed spaced apart from each other along the circumferential direction. In the present embodiment, the nine teeth 31B are disposed equispaced apart from each other along the circumferential direction. The nine teeth 31B are formed integrally with the yoke 31A.

As shown in FIG. 7, the slots 34 are formed between pairs of teeth 31B that are adjacent in the circumferential direction. That is, the stator 30 has nine slots 34 disposed along (around) the circumferential direction.

As shown in FIG. 3, FIG. 5, FIG. 7, and FIG. 8, the stator 30 comprises insulators 32. The insulators 32 are made of, for example, a polymer (synthetic resin) having electrical insulating properties. The insulators 32 cover at least a portion of the surface of the stator core 31.

The stator 30 comprises nine coils 33. Each of the nine coils 33 comprises a wire. Specifically, the insulators 32 cover a coil-mounting surface of each of the nine teeth 31B as well as the outer-circumferential surface of the yoke 31A. The wire of each of the coils 33, from among the nine coils 33, is wound on the corresponding coil-mounting surface. The wire of each of the nine coils 33 contacts the outer-circumferential surface of the yoke 31A. Consequently, the stator core 31 is insulated from the coils 33 by the insulators 32.

In the present embodiment, the stator core 31 and the insulators 32 are integrally molded. The insulators 32 may be fixed to the stator core 31 by insert molding. Specifically, the stator core 31 and the insulators 32 may be formed as described below. First, the stator core 31 is placed (housed) in a mold. Next, heated, molten polymer (synthetic resin) is injected into the mold. When the polymer (synthetic resin) solidifies, the insulators 32 are integrated with (i.e., fixed to) the stator core 31.

The nine coils 33 are respectively disposed in the nine slots 34. Specifically, the nine coils 33 are respectively provided on the nine teeth 31B. The coils 33 (in detail, the wire constituting the coils 33) are wound around the nine teeth 31B. That is, in the state in which the nine coils 33 are wound around the corresponding teeth, each of the coils 33 is provided in spaces that include the two slots 34 on both end sides of the corresponding tooth (see FIG. 7). It is noted that, on each of the nine teeth 31B, the coil-mounting surfaces are covered by the insulators 32, but the majority portion or the entirety of the outer-circumferential surface of the tooth is not covered by the insulators 32. The outer-circumferential surfaces of the teeth are the surfaces thereof that face radially outward (that is, opposing the magnets 23).

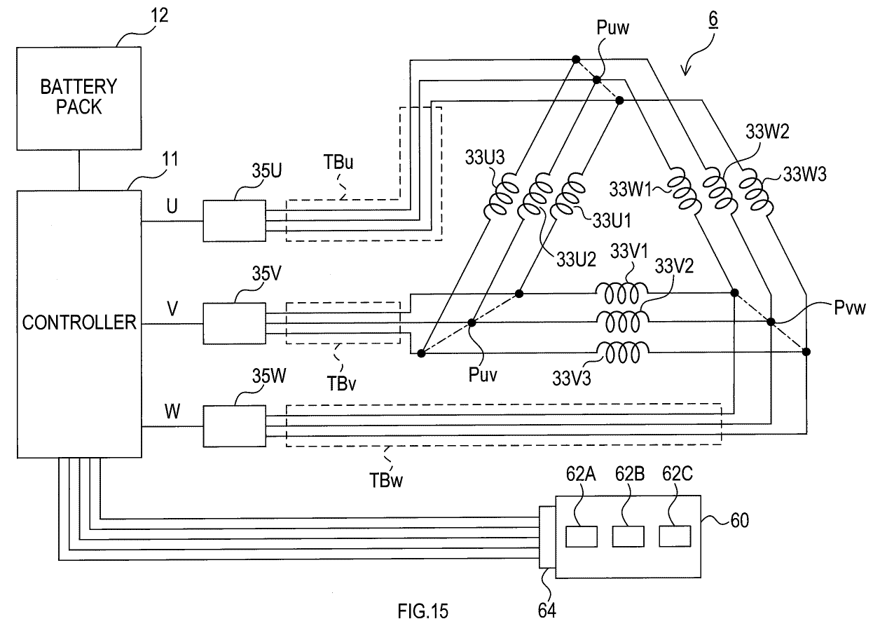

As shown in FIG. 2 to FIG. 5 and FIG. 8, the motor 6 comprises a first fusing terminal 35U, a second fusing terminal 35V, a third fusing terminal 35W, a first tube TBu, a second tube TBv, and a third tube TBw. The first to third fusing terminals 35U, 35V, 35W are electrically connected to the nine coils 33. The first to third fusing terminals 35U, 35V, 35W and the first to third tubes TBu, TBv, TBw will be described in more detail below with reference to FIG. 15.

2-1-2c. Bearings

The motor 6 comprises a plurality of bearings. The rotor shaft 50 passes through the bearings, and the bearings support the rotor shaft 50 (and, in turn, the rotor 20) in a rotatable manner.

In the present embodiment, the plurality of bearings includes a first bearing 54 (see FIG. 5 and FIG. 8) and a second bearing 56 (see FIG. 3, FIG. 5, FIG. 6, and FIG. 8). The first bearing 54 is fitted into a third support portion 41C (see FIG. 3, FIG. 5, and FIG. 8), described below, of the stator base 40. The second bearing 56 is fitted into a first support portion 41A (see FIG. 3, FIG. 5, and FIG. 8), described below, of the stator base 40.

In the present embodiment, the first bearing 54 is in the form of a roller bearing (in detail, a radial roller bearing; in greater detail, a needle roller bearing) and the second bearing 56 is in the form of a ball bearing (in detail, a radial ball bearing).

As shown in FIG. 8, the rotor shaft 50 has a first surface 50A. The first surface 50A corresponds to the area of the surface of the rotor shaft 50 that the first bearing 54 contacts. The rotor shaft 50 further has a second surface 50B. The second surface 50B corresponds to the area of the surface of the rotor shaft 50 that the second bearing 56 contacts.

In the present embodiment, the length of the first surface 50A in the axial direction is greater than the length of the second surface 50B in the axial direction. However, the length of the first surface 50A in the axial direction may also be equal to or less than the length of the second surface 50B in the axial direction.

2-1-2d. Stator Base

The stator base 40 of the present embodiment contains aluminum as its majority element. That is, the stator base 40 contains an aluminum alloy. In the present embodiment, the stator base 40 is integrally formed of an aluminum alloy.

As shown in FIG. 3 to FIG. 5 and FIG. 8, the stator base 40 comprises a support portion 41. The support portion 41 has a tube shape and has a plurality of steps along rotational axis AX. The rotor shaft 50 passes through the support portion 41 in the axial direction.

More specifically, the support portion 41 has the first support portion 41A, the second support portion 41B, and the third support portion 41C, each of which has a tube shape. The first support portion 41A is coupled to the second support portion 41B along rotational axis AX. The second support portion 41B is coupled to the third support portion 41C along rotational axis AX. The outer diameter of the second support portion 41B is greater than the outer diameter of the third support portion 41C. The outer diameter of the first support portion 41A is greater than the outer diameter of the second support portion 41B.

The inner diameter of the first support portion 41A is sized such that the second bearing 56 can be fitted thereinto. The outer diameter of the second support portion 41B is sized such that it can be fitted into a hollow part of the insulator 32, said outer diameter being greater than the inner diameter of a hollow part of the stator core 31 (specifically, a hollow part of the yoke 31A). The inner diameter of the third support portion 41C is sized such that the first bearing 54 can be fitted thereinto and its outer diameter is sized such that the third support portion 41C can be inserted into the hollow part of the stator core 31.

It is noted that FIG. 3 and FIG. 5 show the state in which the rotor shaft 50 has been inserted through the first and second bearings 54, 56. In actuality, however, the first and second bearings 54, 56 are first fixed to the interior of the stator base 40 as described below. Subsequently, the rotor shaft 50 is inserted into the stator base 40 and thereby supported by the first and second bearings 54, 56.

As shown in FIG. 8, the support portion 41 is inserted into the through hole 310 of the stator core 31. More specifically, the third support portion 41C is inserted into the through hole 310.

The stator core 31 is fixed to the third support portion 41C in a first fixation mode and thereby supported by the support portion 41 (and, in turn, by the stator base 40).

In the first fixation mode, there is no deformation of an inner-circumferential surface 415 (see FIG. 11) of the third support portion 41C caused by the stator core 31 being fixed to the third support portion 41C. That is, in the present embodiment, in the process of inserting the stator core 31 into the third support portion 41C and fixing it to the third support portion 41C, deformation of the inner-circumferential surface 415 of the third support portion 41C caused by said insertion and/or fixation does not occur or substantially does not occur.

In the present embodiment, the first fixation mode includes adhesive fixation using an adhesive 45. That is, in the present embodiment, the stator core 31 is adhesively fixed to the third support portion 41C (and, in turn, to the stator base 40) by the adhesive 45.

The first and second bearings 54, 56 may each be fixed to the stator base 40 in any manner.

In the present embodiment, the first bearing 54 is fixed to the third support portion 41C in a second fixation mode. In the second fixation mode, there is or may be deformation of the third support portion 41C caused by the first bearing 54 being fixed to the third support portion 41C. That is, in the present embodiment, in the process of inserting the first bearing 54 into the third support portion 41C and fixing it to the third support portion 41C, deformation of the third support portion 41C caused by said insertion and/or fixation occurs or may occur.

In the present embodiment, the second fixation mode includes press-fitting. That is, the first bearing 54 is press-fitted into the third support portion 41C and thereby fixed to the third support portion 41C.

In the present embodiment, the second bearing 56 is also press-fitted into the first support portion 41A.

However, the first bearing 54 may be fixed to the third support portion 41C by a method other than a press-fitting method. The first bearing 54 may be fixed to the third support portion 41C by, for example, hot shrink fitting, cold shrink fitting, or another method. The same applies to the second bearing 56.

The first bearing 54 is disposed so as to at least partially overlap the stator core 31 and the rotor core 22 in the axial direction. The second bearing 56 does not overlap the stator 30 and the rotor core 22 in the axial direction.

During the assembly of the motor 6, the first bearing 54 and the second bearing 56 are fixed to the stator base 40. Thereafter, the rotor shaft 50 is inserted through the first bearing 54 and the second bearing 56, in this order, and is thereby supported by the stator base 40 (in detail, by the first and second bearings 54, 56). Accordingly, the output shaft 51 of the motor 6 is supported by the first support portion 41A so as to be capable of rotating about rotational axis AX.

As shown in FIG. 3 to FIG. 5 and FIG. 8, the stator base 40 has a mounting portion 42. The mounting portion 42 is formed integrally with the support portion 41. The mounting portion 42 comprises a mounting-portion main body 42A. The mounting-portion main body 42A has the shape of a hollow disc. The mounting-portion main body 42A is provided at an outer-circumferential portion of the first support portion 41A.

The mounting portion 42 includes a first mounting portion 42B, a second mounting portion 42C, and a third mounting portion 42D. Any one or two of the first mounting portion 42B, the second mounting portion 42C, and the third mounting portion 42D may be omitted.

The first mounting portion 42B, the second mounting portion 42C, and the third mounting portion 42D each protrude radially outward from the mounting-portion main body 42A. The first mounting portion 42B, the second mounting portion 42C, and the third mounting portion 42D each have a hole SH in tip portions thereof. The tip portions correspond to the end portions on the side opposite the mounting-portion main body 42A. A screw (not shown) is inserted into each hole SH. The screws are threaded into screw holes (not shown) provided in an inner surface of the housing 2, whereby the mounting portion 42 (and, in turn, the motor 6) is fixed to the housing 2. It is noted that the mounting portion 42 may be indirectly mounted on the housing 2. That is, one or more other structural elements may be interposed between the mounting portion 42 and the housing 2.

A base-plate fixation portion 42E is provided between the first mounting portion 42B and the second mounting portion 42C. The base-plate fixation portion 42E fixes the sensor board 60. The base-plate fixation portion 42E has a shape corresponding to the shape of the sensor board 60—specifically, an arcuate shape centered on rotational axis AX.

As shown in FIG. 3 and FIG. 5, the base-plate fixation portion 42E has, at a first end thereof, a first hole 43 and a first pin 43A. The first pin 43A is inserted into the first hole 43. Specifically, in the present embodiment, the first pin 43A is press-fitted into the first hole 43.

The base-plate fixation portion 42E has, at a second end thereof, a second hole 44 and a second pin 44A. The second pin 44A is inserted into the second hole 44. Specifically, in the present embodiment, the second pin 44A is press-fitted into the second hole 44.

The first pin 43A is inserted into a third hole 65 in the sensor board 60. The second pin 44A is inserted into a fourth hole 66 in the sensor board 60. FIG. 2 shows the state in which the first pin 43A is inserted into the third hole 65. In the present embodiment, the first pin 43A and the second pin 44A are fitted into the third hole 65 and the fourth hole 66, respectively, with clearance fits. The sensor board 60 is positioned at a defined location relative to the stator base 40 (and, in turn, relative to the stator 30) by the first pin 43A and the second pin 44A.

2-1-2e. Sensor Board

The sensor board 60 comprises three magnetic sensors 62A, 62B, 62C. Each of the three magnetic sensors 62A, 62B, 62C detects changes in the magnetic field accompanying the rotation of the rotor 20 and outputs a detection signal according to the detected changes (i.e., according to the rotational position of the rotor 20).

The sensor board 60 is supported by the stator base 40 such that the three magnetic sensors 62A, 62B, 62C respectively oppose the twelve magnets 23 in the axial direction. The sensor board 60 is disposed more radially outward than the nine coils 33.

The sensor board 60 comprises a connection terminal 64. The connection terminal 64 is electrically connected to the magnetic sensors 62A, 62B, 62C and the controller 11. The connection terminal 64 electrically connects the magnetic sensors 62A, 62B, 62C to the controller 11. The sensor board 60 has the third hole 65 and the fourth hole 66 described above.

2-1-2f. Fixation of Stator to Stator Base

A method of fixing the stator 30 to the stator base 40 will be described in more detail with reference to FIG. 11, FIG. 13, and FIG. 14. It is noted that, in FIG. 11, FIG. 13, and FIG. 14, only the stator core 31 of the stator 30 is excerpted and shown for simplicity and clarity of description.

On the stator base 40, as shown in FIG. 11, the third support portion 41C has the inner-circumferential surface 415 described above. When the first bearing 54 is press-fitted into the third support portion 41C, an outer-circumferential surface 54A of the first bearing 54 is press-fitted and thereby tightly contacts to the inner-circumferential surface 415 of the third support portion 41C. The first bearing 54 is thereby fixed to the third support portion 41C.

The third support portion 41C has an outer-circumferential surface 411. The outer-circumferential surface 411 is inserted into the through hole 310 of the stator core 31 and opposes a stator inner-circumferential surface 310B. The stator inner-circumferential surface 310B corresponds to the inner-circumferential surface of the through hole 310.

The outer-circumferential surface 411 has an outer-circumferential flat-surface area 411A. Although the outer-circumferential surface 411 is a curved surface overall, the outer-circumferential flat-surface area 411A is a flat surface. The outer-circumferential flat-surface area 411A corresponds to a portion of the outer-circumferential surface 411.

As shown in FIG. 11 and FIG. 13, the through hole 310 of the stator core 31 has an opening 310A. The third support portion 41C and the rotor shaft 50 protrude leftward from (beyond, out of) the opening 310A.

The through hole 310 has the stator inner-circumferential surface 310B, which opposes the outer-circumferential surface 411 of the third support portion 41C. The through hole 310 has an inner-circumferential flat-surface area 311 on the stator inner-circumferential surface 310B. The third support portion 41C is inserted into the through hole 310 such that the outer-circumferential flat-surface area 411A thereof opposes the inner-circumferential flat-surface area 311 of the through hole 310 (see FIG. 14). By inserting the third support portion 41C into the through hole 310 and fixing it therein in this manner, movement of the stator core 31 in the circumferential direction relative to the stator base 40 is restricted (blocked).

The through hole 310 has a plurality of recessed portions 315 on the stator inner-circumferential surface 310B. Each of the recessed portions 315 extends on the stator inner-circumferential surface 310B along rotational axis AX from the opening 310A to an opening on the right.

In the present embodiment, the through hole 310 has five of the recessed portions 315. However, the through hole 310 may have any number of the recessed portions 315. The through hole 310 may have one or a plurality of the recessed portions 315. The through hole 310 need not necessarily have the recessed portions 315.

As shown in FIG. 14, the motor 6 has a slight clearance 316 between the stator inner-circumferential surface 310B and the outer-circumferential surface 411 of the third support portion 41C. The clearance 316 includes the plurality of recessed portions 315. By filling the adhesive 45 into the clearance 316, the stator core 31 is fixed to the third support portion 41C.

### 2-1-3. Electrical Configuration of Electric Work Machine

The schematic electrical configuration of the electric work machine 1 will now be described, principally with reference to FIG. 15.

The nine coils 33 of the motor 6 can be divided into a first-phase coil group, a second-phase coil group, and a third-phase coil group. The first-phase coil group includes one set of first-phase coils 33U1, 33U2, 33U3 connected in parallel with each other. The second-phase coil group includes one set of second-phase coils 33V1, 33V2, 33V3 connected in parallel with each other. The third-phase coil group includes one set of third-phase coils 33W1, 33W2, 33W3 connected in parallel with each other. Furthermore, the first-phase coil group, the second-phase coil group, and the third-phase coil group are delta-connected to each other. It is noted that the chain line in FIG. 15 indicates an electrical connection (in detail, a short circuit or conductive path).

From a different perspective, the motor 6 can be said to comprise three delta-connected groups. The first delta-connected group includes the first-phase coil 33U1, the second-phase coil 33V1, and the third-phase coil 33W1 delta-connected to each other. The second delta-connected group includes the first-phase coil 33U2, the second-phase coil 33V2, and the third-phase coil 33W2 delta-connected to each other. The third delta-connected group includes the first-phase coil 33U3, the second-phase coil 33V3, and the third-phase coil 33W3 delta-connected to each other. Furthermore, the first to third delta-connected groups are connected to each other in parallel.

Furthermore, the first end of each of the first-phase coils 33U1, 33U2, 33U3 and the second end of each of the third-phase coils 33W1, 33W2, 33W3 are connected to the first fusing terminal 35U via a first plurality of lead lines. A portion of the first plurality of lead lines in the vicinity of the first fusing terminal 35U is bundled together and inserted through the first tube TBu.

The second end of each of the first-phase coils 33U1, 33U2, 33U3 and the first end of each of the second-phase coils 33V1, 33V2, 33V3 are connected to the second fusing terminal 35V via a second plurality of lead lines. A portion of the second plurality of lead lines in the vicinity of the second fusing terminal 35V is bundled together and inserted through the second tube TBv.

The second end of each of the second-phase coils 33V1, 33V2, 33V3 and the first end of each of the third-phase coils 33W1, 33W2, 33W3 are connected to the third fusing terminal 35W via a third plurality of lead lines. A portion of the third plurality of lead lines in the vicinity of the third fusing terminal 35W is bundled together and inserted through the third tube TBw.

The first to third fusing terminals 35U, 35V, 35W are electrically connected to the controller 11.

It is noted that the nine coils 33 may be connected in any manner. For example, pairs of the first-phase coils 33U1, 33U2, 33U3 in the first-phase coil group may be connected to each other in series. The same applies to the second-phase and third-phase coil groups.

In addition, the first-phase coil 33U1, the second-phase coil 33V1, and the third-phase coil 33W1 may be, for example, star-connected. The same applies to the first-phase coil 33U2, the second-phase coil 33V2, and the third-phase coil 33W2, and the same applies to the first-phase coil 33U3, the second-phase coil 33V3, and the third-phase coil 33W3.

In addition, the motor 6 of the present embodiment has a prescribed motor-resistance value. Here, as shown in FIG. 15, three electrical connection points of the first-phase coil group, the second-phase coil group, and the third-phase coil group, which are delta-connected to each other, are referred to as Puw, Puv, Pvw. The motor-resistance value is the resistance value between any two of the connection points Puw, Puv, Pvw or the resistance value in an electrically equivalent region (conductive path) between these two connection points. Accordingly, the motor-resistance value may be defined as the resistance value between any two of the first to third fusing terminals 35U, 35V, 35W.

In the present embodiment, the motor-resistance value between the connection point Puw and the connection point Puv, the motor-resistance value between the connection point Puv and the connection point Pvw, and the motor-resistance value between the connection point Pvw and the connection point Puw are equal.

The controller 11 receives battery power from the battery pack 12. The controller 11 comprises, for example, a control circuit, a power-supply circuit, and a drive circuit, none of which are shown.

The drive circuit receives battery power. The drive circuit is, for example, in the form of a three-phase, full-bridge circuit. That is, the drive circuit comprises six semiconductor switching elements. The six semiconductor switching elements are individually controlled by control instructions from the control circuit. The drive circuit converts the battery power to motor-drive electric power (three-phase power) described above and supplies the same to the motor 6 in accordance with the control instructions from the control circuit. The motor-drive electric power is supplied to the motor 6 via the first to third fusing terminals 35U, 35V, 35W, whereby the motor 6 is driven.

More specifically, the drive circuit applies battery voltage (rated voltage of 36 V in the present embodiment) between any two fusing terminals, from among the first to third fusing terminals 35U, 35V, 35W, corresponding to the rotational position of the motor 6 by turning ON the two semiconductor switching elements corresponding to that rotational position of the motor 6. At this time, one of the two semiconductor switching elements is, for example, kept ON while the other is periodically turned ON and OFF according to a pulse-width modulation signal.

The control circuit adjusts the magnitude of the motor-drive electric power supplied to the coils 33 by changing the duty cycle of the pulse-width modulation signal. In addition, the two semiconductor switching elements turned ON are switched according to the rotational position of the motor 6.

The control circuit comprises one or more microcomputers, storage and memory. The control circuit is configured to execute various programs stored in the storage. Various functions of the electric work machine 1 are realized by the control circuit executing the various programs. The functions implemented by the control circuit include, inter alia, a function of controlling the drive circuit.

The connection terminal 64 of the sensor board 60 is connected to the controller 11 via a lead group. The lead group comprises two lead lines that supply electric power to the three magnetic sensors 62A, 62B, 62C and three lead lines that transmit the detection signals from the three magnetic sensors 62A, 62B, 62C to the controller 11.

The control circuit detects the rotational position (i.e., the electrical angle) of the rotor 20 based on the three detection signals inputted to the controller 11. Based on the detected rotational position and other drive information, the control circuit generates control instructions and outputs the same to the drive circuit. The motor-drive electric power corresponding to the rotational position of the rotor 20 is thereby supplied to the motor 6. The drive information includes, for example, an amount of manipulation of the trigger switch 7.

### 2-1-4. Motor Features

The features of the motor 6 according to the present embodiment will be described in detail.

### 2-1-4-1. Definitions of Dimensions

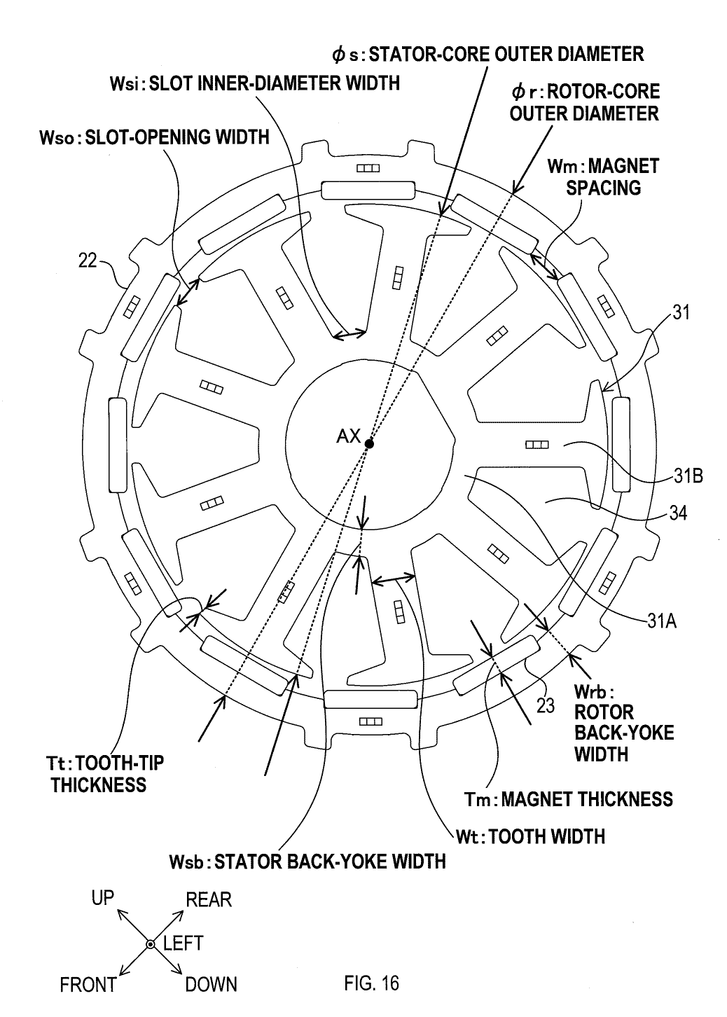

First, the dimensions of the various regions of the motor 6, as used in the following description, are defined as shown in FIG. 16 and FIG. 11.

In FIG. 16, rotor-core outer diameter er (in mm) is the outer diameter of the rotor core 22, i.e., the length thereof in the radial direction orthogonal to rotational axis AX. Magnet thickness Tm (in mm) is the thickness of the magnets 23, i.e., the length (depth) of the magnets 23 in the radial direction.

Magnet spacing Wm (in mm) is the distance between two of the magnets 23 adjacent to each other in the circumferential direction. In detail, it is the shortest distance when the rotor 20 is viewed in the direction shown in FIG. 16.

Rotor back-yoke width Wrb (in mm) is the thickness of the rotor core 22, i.e., the length of the rotor core 22 in the radial direction.

Stator-core outer diameter os (in mm) is the outer diameter of the stator core 31, i.e., the length of the stator core 31 in the radial direction.

Stator back-yoke width Wsb (in mm) is the width of the yoke 31A of the stator core 31, i.e., the length of the yoke 31A in the radial direction.

Tooth width Wt (in mm) is the width of the teeth 31B. Specifically, it is the length in a direction that is parallel to a plane orthogonal to rotational axis AX and orthogonal to the radial direction.

Slot inner-diameter width Wsi (in mm) is the distance between the bases of two of the teeth 31B adjacent to each other in the circumferential direction. The bases of the teeth 31B are the regions where the teeth 31B begin to protrude from the outer circumference of the yoke 31A in the radial direction, i.e., the bottom ends of the teeth 31B that are connected to the yoke 31A.

Slot-opening width Wso (in mm) is the straight-line distance of the radially outward openings of the slots 34 along the circumferential direction. It is noted that the teeth 31B include, in detail, main-body portions extending radially outward from the yoke 31A and flanged tip portions provided at the tip portions of the main-body portions. The widths of the main-body portions correspond to the aforementioned tooth width Wt. In addition, the distance between the tip portions of two of the teeth 31B adjacent in the circumferential direction corresponds to the aforementioned slot-opening width Wso.

Tooth-tip thickness Tt (in mm) is the length of circumferential-direction end portions of the tip portions of the teeth 31B in the radial direction.

In addition, Ds shown in FIG. 11 is the stator thickness (in mm), which is the length of the stator core 31 in the axial direction (i.e., the left-right direction).

It is noted that the definitions of the various dimensions described above are merely examples, and the above-described dimensions may be defined in any manner.

### 2-1-4-2. Overview of Motor Features

The inventors of the present application conducted various investigations to find a motor structure that is compact and has the desired output.

In these investigations, it was assumed that the motor is an outer-rotor type in the form of a brushless motor. It was also a precondition that the motor is an SPM type and that the permanent magnets are Nd—Fe—B sintered magnets.

Furthermore, investigation ranges were set for each of the various parameters of the motor, as shown in Table 1 below.

Table 1

| PARAMETER | INVESTIGATION RANGE |
|---|---|
| Pole-slot combination | 6P9S, 8P6S, 8P12S, 10P12S, 10P15S, |
| | 12P9S, 12P18S, 14P12S, 14P15S, |
| | 14P18S, etc. |
| Rotor outer diameter ør (in mm) | 55, 60, 65, 70, 75, 80 |
| Slot inner-diameter width Wsi (in mm) | 3.0, 4.0, 5.0 |
| Tooth width Wt (in mm) | 3.0, 4.0, 5.0, 6.0, 7.0 |
| Back-yoke width Wrb, Wsb (in mm) | 1.5, 2.0, 2.5, 3.0, 3.5 |
| Slot-opening width Wso (in mm) | 3.0, 4.0, 5.0, 6.0, 7.0, 8.0 |
| Tooth-tip thickness Tt (in mm) | 1.5 |
| Magnet spacing Wm (in mm) | 3.0, 4.0, 5.0, 6.0, 7.0 |
| Magnet thickness Tm (in mm) | 2.0 |
| Motor-resistance value R (in mΩ) | 6.1, 11.0, 21.8, 30.8, 33.1 |
| Drive voltage Vd (in V) | 18, 36, 72 |
| Theoretical unloaded rotational speed Nn (in | 14,000 |
| rpm) | |

The investigation ranges in Table 1, other than that for drive voltage Vd, are ranges applicable to various types of electric work machines, including the electric work machine 1, and, in particular, are ranges in which a high output density can be achieved. It is noted that “output density” is motor output P per unit of motor volume.

For example, the investigation range for the rotor-core outer diameter er is set taking into consideration the motor size, motor output P, and the like required for various types of electric work machines. For example, the investigation range for the motor-resistance value R is set taking into consideration the required motor output P.

In the above-mentioned table, “pole-slot combination” indicates the combination of the number of magnetic poles and the number of slots; for example, “6P9S” means six poles and nine slots.

The slot inner-diameter width Wsi (in mm) is set such that, even if coils having a prescribed wire diameter (e.g., 1.1 mm) are used, two coils adjacent in the circumferential direction do not interfere (e.g., make contact) with each other.

The slot-opening width Wso (in mm) is set contemplating the coils being wound, for example, by using a flyer winding method. In other words, a range is set in which, in the state in which the insulators have been provided on the stator core, the wire constituting the coils can be satisfactorily inserted from the slot openings into the slots.

In addition, drive voltage Vd (in V) refers to the battery voltage described above. Although the battery voltage of the electric work machine 1 of the present embodiment is, for example, rated at 36 V as described above, the three drive voltages Vd shown in Table 1 were utilized in the investigation. These three drive voltages Vd have a high likelihood of being used in various types of electric work machines.

Motor-resistance value R (in mΩ) is set to a value such that the motor can be continuously driven under load at a rotational speed of 12,000 rpm and an electric current of approximately 60 A supplied to the motor. The term “under load” means the state in which a load from an external workpiece is being applied to the motor via the driven tool accessory, i.e., the state in which work is actually being performed by the electric work machine. “Continuously driven” means that the motor is driven such that the temperature of the coils is maintained within the device's rating (permissible operating temperature range) even in a high-temperature environment (e.g., 40° C.).

In addition, theoretical unloaded rotational speed Nn (in rpm) is the rotational speed in an ideal state in which no external load whatsoever is being applied to the rotor. For example, in the electric work machine 1 in the above-mentioned embodiment, the state in which the saw chain 10 is idling without contacting the workpiece can generally be referred to as an unloaded state. However, in the unloaded state, although the load from the workpiece applied via the saw chain 10 is zero (or substantially zero), the load applied to the rotor 20 is not completely zero. Even in the unloaded state, loads caused by various types of external disturbances, such as transmission losses by the motive-power-transmitting part 13, losses caused by the rotor cup 21, and the like, are applied to the rotor 20. The theoretical unloaded rotational speed Nn is the rotational speed in an ideal state in which no such external-disturbance-based loads whatsoever are being applied.

In addition, when the rotor is being rotated in an ideal state, the back EMF and the drive voltage Vd generated by the motor are in balance (i.e., match), and the current from the battery to the motor becomes zero. Accordingly, the theoretical unloaded rotational speed Nn can also be defined as the rotational speed when, in an ideal state, the current from the battery to the motor becomes zero.

Here, an additional explanation concerning back EMF will be provided. In general, it is known that, when a rotor having permanent magnets is rotated, back EMF caused by electromagnetic induction is generated in the stator-side coils. Techniques for detecting the rotational position of the rotor based on this back EMF are also generally known.

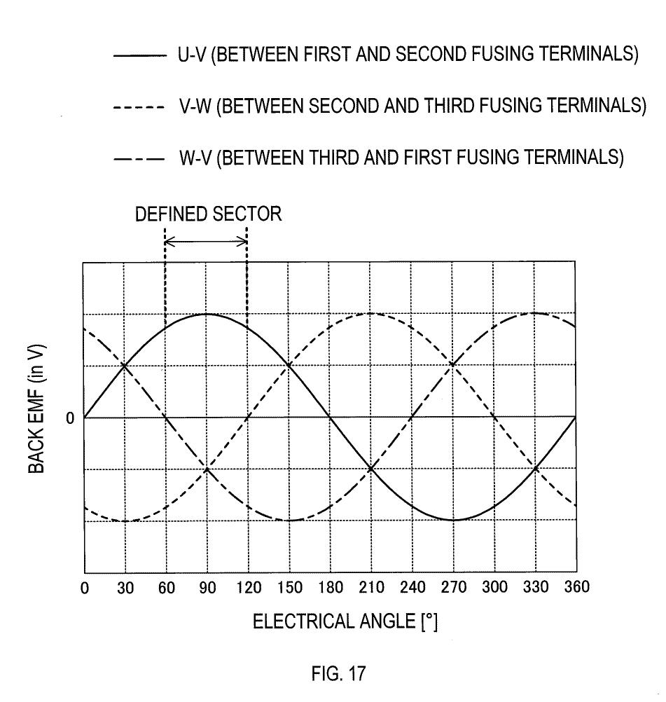

In the motor 6 of the present embodiment as well, when the rotor 20 is rotated, back EMF is generated in each of the nine coils 33, and, in turn, back EMF is generated between two of the first to third fusing terminals 35U, 35V, 35W, as illustrated in FIG. 17.

Here, as illustrated in FIG. 17, a prescribed electrical-angle range that includes the electric angle at which the back EMF between the two terminals is greatest (between U and V, 90°) is defined as a defined sector. In the present embodiment, the angular width of the defined sector is 60°. However, the angular width may differ from 60°. Between U and V, the defined sector is the sector defined by electrical angles of 60°-120°.

In the present embodiment, the average value of the back EMF within this defined sector is referred to as effective back EMF value E. The effective back EMF value E indicates the effective (or equivalent) magnitude of the back EMF, which varies periodically. The effective back EMF value E is proportional (or substantially proportional) to the rotational speed of the rotor. That is, the effective back EMF value E also increases linearly (or substantially linearly) relative to the increase in the rotational speed of the rotor. In the present embodiment, the effective back EMF value E is the same between any two terminals.

The inventors investigated optimal designs for a motor that is compact and capable of a high output by calculating various evaluation values (e.g., back-EMF constant k, coefficient α, etc., described below) for arbitrary combinations of various parameters within the investigation ranges shown in Table 1.

As a result, it was found that an optimal motor having a high output density could be realized by further satisfying First to Tenth Conditions (described below) under the preconditions described above. The motor 6 according to the present embodiment satisfies all the First to Tenth Conditions. It is noted that any one or more of the First to Tenth Conditions may be satisfied.

### (i) First Condition

The pole-slot combination motor is a 12-pole, 9-slot motor.

### (ii) Second Condition

Back-EMF constant k (in V/krpm) satisfies the condition 1.1≤k≤9.0.

The back-EMF constant k is calculated using the numerical formula “k=E/N”. In this numerical formula, N (in krpm) is the rotational speed of the motor (i.e., the rotational speed of the rotor). E (in V) indicates the magnitude of the back EMF generated by the motor 6 when the rotor is rotating at rotational speed N. That is, E (in V) indicates the effective back EMF value E when the rotor is rotating at rotational speed N.

(iii) Third Condition
Coefficient α (in mΩ/(V/krpm)²) satisfies the condition 0.2≤α≤19.0.

The coefficient α is calculated using the numerical formula “α=R/k²”. In this equation, R (in mΩ) is the motor-resistance value described above. k (in V/krpm) is the back-EMF constant described above.

### (iv) Fourth Condition

Rotor-core outer diameter ør (in mm) satisfies the condition 55≤ør≤80.

### (v) Fifth Condition

Stator-core outer diameter øs (in mm) satisfies the condition 40≤øs≤72.5.

### (vi) Sixth Condition

Rotor-flatness ratio ηr satisfies the condition 0.1≤ηr≤0.7.

The rotor-flatness ratio ηr is calculated using the numerical formula “ηr=Ds/ør”. The meanings of Ds (in mm) and ør (in mm) in this numerical formula are as described above.

(vii) Seventh Condition

Stator-flatness ratio ηs satisfies the condition 0.1≤ηs≤0.8.

The stator-flatness ratio ηs is calculated using the numerical formula “ηs=Ds/øs”. The meanings of Ds (in mm) and øs (in mm) in this numerical formula are as described above.

(viii) Eighth Condition

Rotor-flatness-ratio density ξr (in kW⁻¹) satisfies the condition fr2≤ξr≤fr1.

The rotor-flatness-ratio density ξr is calculated using the numerical formula “ξr=ηr/P”. In this numerical formula, ηr is the aforementioned rotor-flatness ratio. P (in kW) is the output of the motor 6.

fr1 is represented by the following Equation (1):

$$fr 1 = 0.000465 ∅ {r}^{2} - 0.0782 ∅ r + 3.43 \qquad ( 1 )$$

fr2 is represented by the following Equation (2):

$$fr 2 = 0.000443 ∅ {r}^{2} - 0.0698 ∅ r + 2.79 \qquad ( 2 )$$

However, it is a required condition that the rotor-core outer diameter ør is 55≤ør≤80.

### (ix) Ninth Condition

Stator-flatness-ratio density ξs (in kW⁻¹) satisfies the condition fs2≤ξs≤fs1.

The stator-flatness-ratio density ξs is calculated using the numerical formula “ξs=ηs/P”. In this numerical formula, ηs is the stator-flatness ratio described above. P (in kW) is the output described above.

fs1 is represented by the following Equation (3):

$$fs 1 = 0.00105 ∅ {s}^{2} - 0.144 ∅ s + 5.13 \qquad ( 3 )$$

fs2 is represented by the following Equation (4):

$$fs 2 = 0.000665 ∅ {s}^{2} - 0.0887 ∅ s + 3. \qquad ( 4 )$$

However, it is a required condition that the stator-core outer diameter øs is 45≤øs≤70.

### (x) Tenth Condition

Slot-opening width Wso (in mm) satisfies the condition 0.04 øs≤Wso≤0.18 øs.

Each of the First to Tenth Conditions is described more specifically below.

2-1-4-2a. First Condition

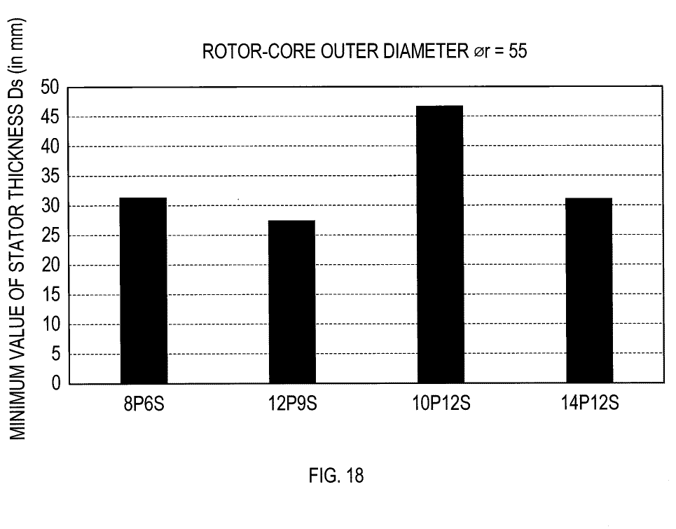

The minimum value of the stator thickness Ds (hereinafter referred to as “minimum stator thickness”) when the other parameters were variously varied was evaluated for each of the pole-slot combinations set in the investigation range. In the evaluations, a precondition was that continuous driving of the motor was possible at a drive voltage Vd of 36 Va, a theoretical unloaded rotational speed Nn of 14,000 rpm, and a motor output P of 1.5 kW. Furthermore, the minimum required stator thickness was investigated for each of various combinations of parameters other than these preconditions. The results are shown in FIG. 18 to FIG. 23.

FIG. 18 shows the minimum stator thickness when the rotor-core outer diameter ør=55. In this situation, the minimum stator thickness is the smallest when the pole-slot combination is 12 poles and 9 slots (12P9S), and that value is approximately 27 mm.

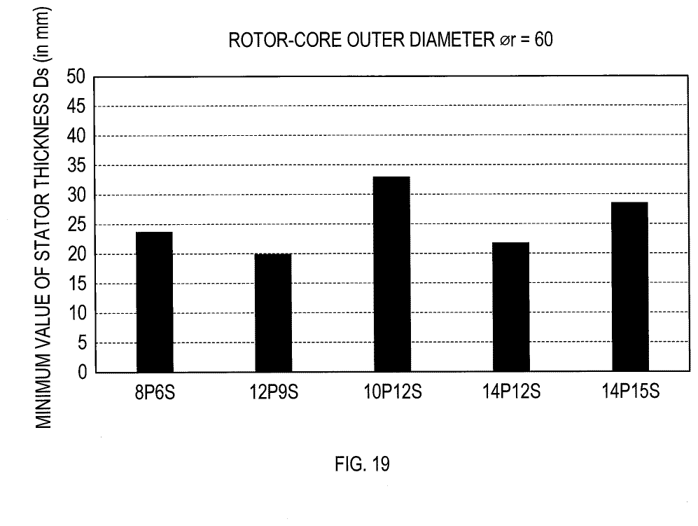

FIG. 19 shows the minimum stator thickness when the rotor-core outer diameter ør=60. In this situation, the minimum stator thickness is the smallest when the pole-slot combination is 12 poles and 9 slots (12P9S), and that value is approximately 20 mm.

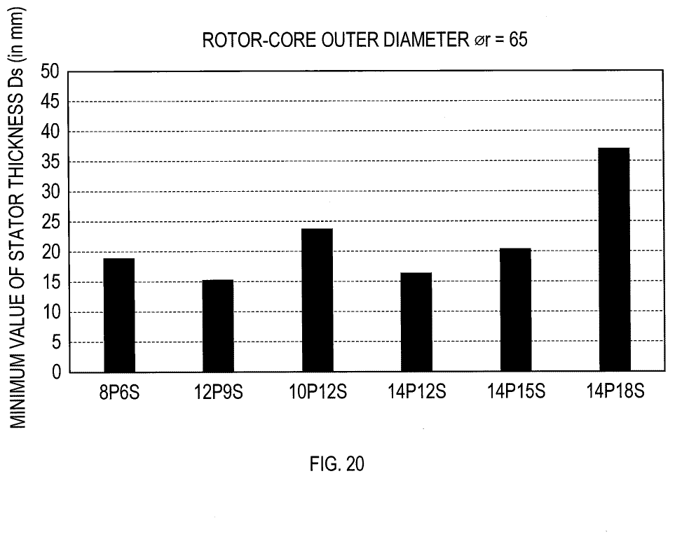

FIG. 20 shows the minimum stator thickness when the rotor-core outer diameter ør=65. In this situation, the minimum stator thickness is the smallest when the pole-slot combination is 12 poles and 9 slots (12P9S), and that value is approximately 15 mm.

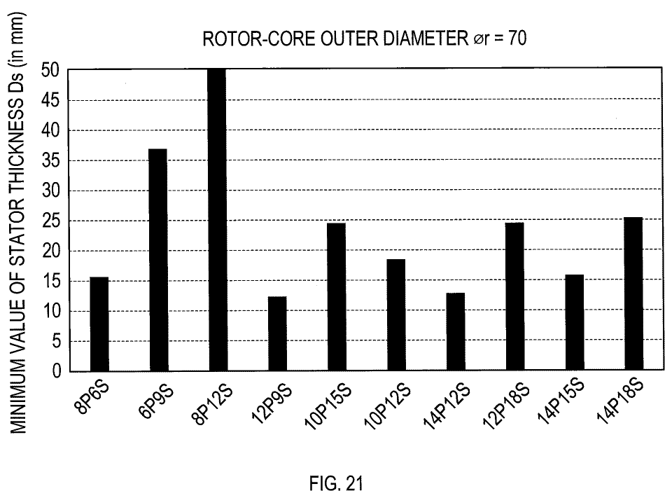

FIG. 21 shows the minimum stator thickness when the rotor-core outer diameter ør=70. In this situation, the minimum stator thickness is the smallest when the pole-slot combination is 12 poles and 9 slots (12P9S), and that value is approximately 12 mm.

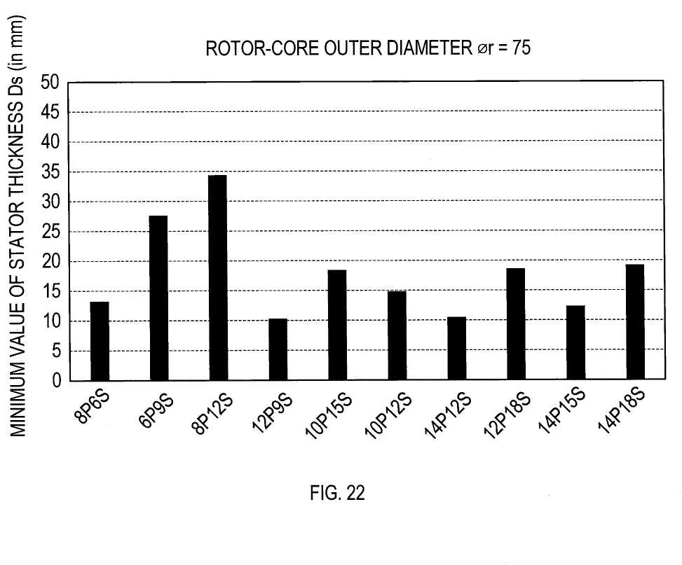

FIG. 22 shows the minimum stator thickness when the rotor-core outer diameter ør=75. In this situation, the minimum stator thickness is the smallest when the pole-slot combination is 12 poles and 9 slots (12P9S), and that value is approximately 10 mm.

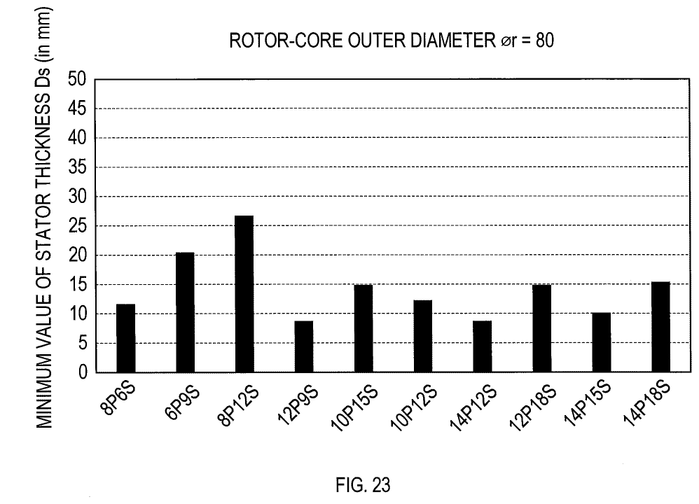

FIG. 23 shows the minimum stator thickness when the rotor-core outer diameter ør=80. In this situation, the minimum stator thickness is the smallest when the pole-slot combination is 12 poles and 9 slots (12P9S), and that value is approximately 8 mm.

For simplicity of description, FIG. 18 to FIG. 23 show only pole-slot combinations for which the minimum stator thickness is 50 mm or less. That is, it may be understood that, for pole-slot combinations not shown in the drawings, the minimum stator thickness is greater than 50 mm and/or the combination of shape parameters is not geometrically feasible.

As is clear from FIG. 18 to FIG. 23, the pole-slot combination having the smallest minimum stator thickness was 12 poles and 9 slots for every rotor-core outer diameter ør. This shows that the stator thickness Ds is kept to a minimum, and, in turn, the compactness of the motor can be maximized, by using a 12-pole, 9-slot configuration.

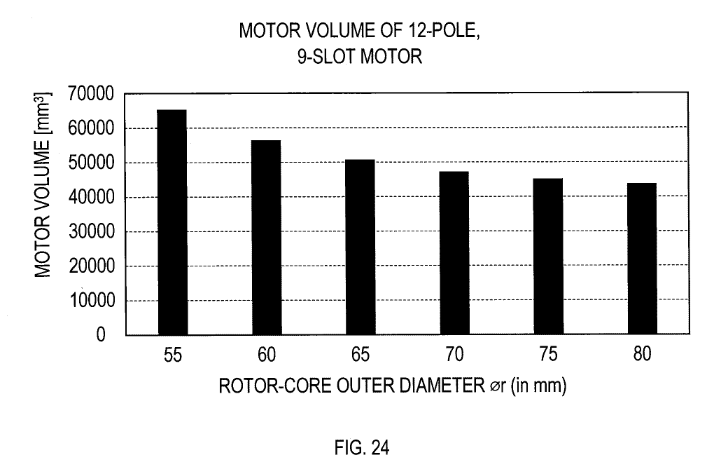

It is noted that, as is clear from FIG. 18 to FIG. 23, the more rotor-core outer diameter ør increases, the smaller the minimum value of the stator thickness Ds becomes in a 12-pole, 9-slot configuration. Accordingly, as shown in FIG. 24, the larger rotor-core outer diameter er is, the smaller the volume of the motor as a whole can be made. It is noted that the motor volume in FIG. 24 is the value of the rotor-core outer diameter er multiplied by the minimum value of stator thickness Ds.

2-1-4-2b. Second and Third Conditions

As described above, it was concluded that the optimal pole-slot combination that enables a high output density is 12 poles and 9 slots.

Therefore, focusing on a 12-pole, 9-slot configuration, additional conditions for achieving a high output density were further investigated.

Specifically, the back-EMF constant k and the coefficient α at which the design target motor output P at the target theoretical unloaded rotational speed Nn is possible were investigated. Achieving the target motor output P is synonymous with setting the motor-resistance value to any one of the various motor-resistance values R shown in Table 1.

In addition, in the investigation, the drive voltage Vd was variously set to 18 V, 36 V, and 72 V, and the theoretical unloaded rotational speed Nn was variously set to 8,000 rpm, 10,000 rpm, 12,000 rpm, 14,000 rpm, and 16,000 rpm.

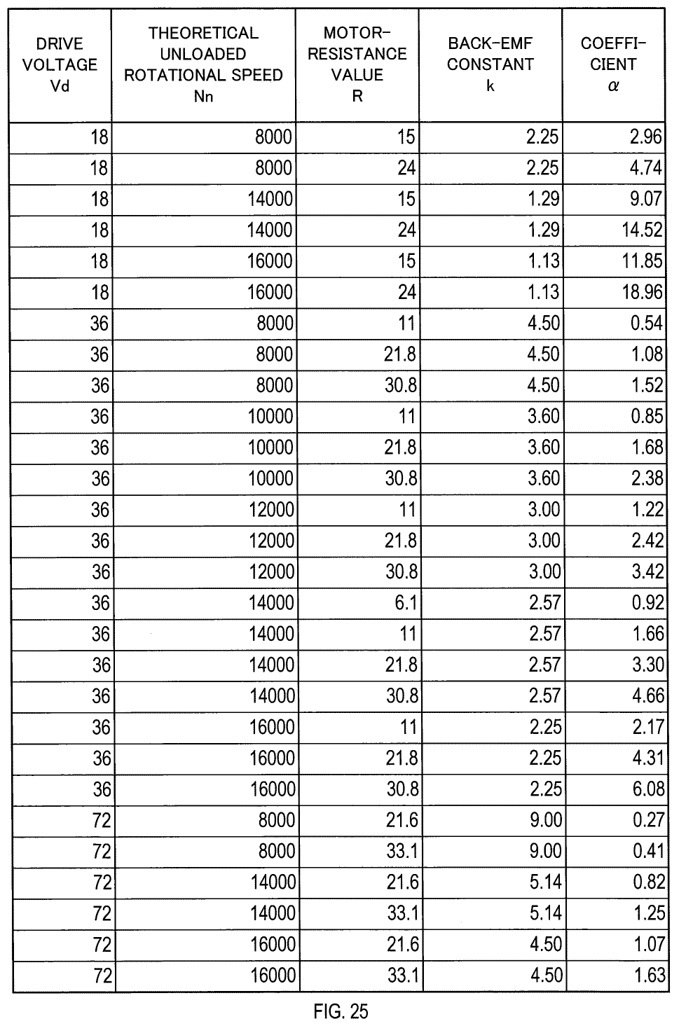

As a result, the investigation results shown in FIG. 25 were obtained. FIG. 25 shows the results for the back-EMF constant k and the coefficient α calculated for various combinations of contemplated design conditions (drive voltage, theoretical unloaded rotational speed, and motor-resistance value).

In FIG. 25, the minimum value of the back-EMF constant k is 1.13, and the maximum value of the back-EMF constant k is 9.00. In addition, the minimum value of the coefficient α is 0.27, and the maximum value of the coefficient α is 18.96.

FIG. 25 shows that a higher output density can be achieved while achieving the desired performance as long as the motor is designed is such that the back-EMF constant k satisfies, for example, the condition 1.13≤k≤9.0. In the present embodiment, allowing for some margin, it was concluded that the required specifications can be satisfied as long as the back-EMF constant k at least satisfies the condition 1.1≤k≤9.0 (i.e., the second condition).

FIG. 25 further shows that a higher output density can be achieved while achieving the desired performance as long as the motor is designed is such that the coefficient α satisfies, for example, the condition 0.27≤α≤18.96. In the present embodiment, allowing for some margin, it was concluded that the required specifications can be satisfied as long as the coefficient α satisfies the condition 0.2≤α≤19.0 (i.e., the third condition).

It is noted that, if the drive voltage of 72 V may be excluded, then the minimum value of the coefficient α is 0.54. Therefore, in this situation, it can be said that it is possible to realize a higher output density while achieving the desired performance as long as the motor is designed is such that the coefficient α satisfies, for example, the condition 0.54≤α≤18.96. Accordingly, in this situation, the third condition may be that the coefficient α satisfies the condition 0.4≤α≤19.0, allowing for some margin.

2-1-4-2c. Sixth and Eighth Conditions

Further conditions for realizing a high output density in a 12-pole, 9-slot configuration were investigated. Specifically, the rotor-flatness ratio ηr was evaluated. The rotor-flatness ratio ηr is the ratio of the stator thickness Ds to the rotor-core outer diameter or.

In addition, the rotor-flatness-ratio density ξr was evaluated. The rotor-flatness-ratio density ξr is the ratio of the rotor-flatness ratio ηr per unit of motor output (in the present embodiment, 1 kW).

Here, for each of the rotor-core outer diameters or shown in FIG. 18 to FIG. 23, the optimal design range for the stator thickness Ds (hereinafter referred to as the “optimal stator thickness”) was defined as being equal to or greater than the minimum stator thickness and equal to or less than a prescribed multiple of the minimum stator thickness. The prescribed multiple may be determined, as appropriate; in the present embodiment, it was set to 1.1 times.

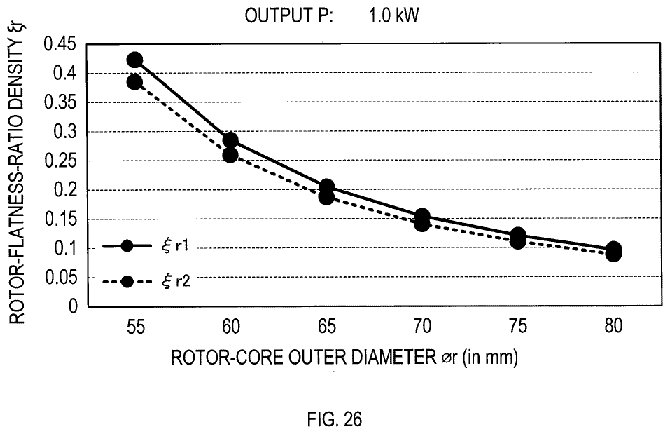

First density ξr1 and second density ξr2 were then evaluated for each rotor-core outer diameter ør. The first density ξr1 is the rotor-flatness-ratio density ξr in a motor capable of realizing the desired motor output P when the stator thickness Ds is the upper-limit value of the optimal stator thickness (i.e., 1.1 times the minimum stator thickness). The second density ξr2 is the rotor-flatness-ratio density ξr in a motor capable of realizing the desired motor output P when the stator thickness Ds is the minimum stator thickness. The evaluation results are shown in FIG. 26 to FIG. 29.

FIG. 26 shows the first and second densities ξr1, ξr2 when the continuously outputtable motor output P is 1.0 kW. In FIG. 26, when the rotor-core outer diameter ør is, for example, 65 mm, the second density ξr2 is approximately 0.18, and the first density ξr1 is approximately 0.205.

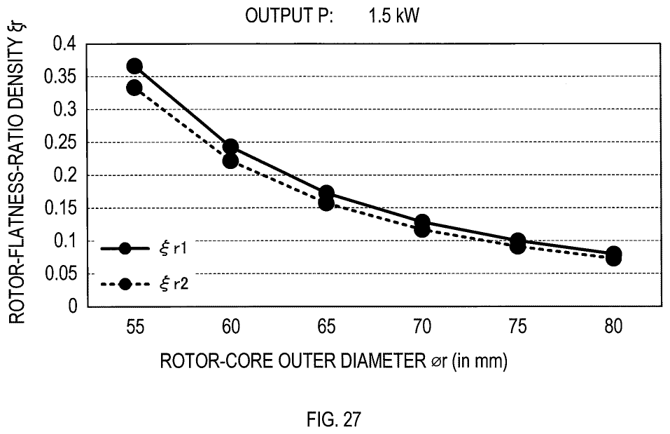

FIG. 27 shows the first and second densities ξr1, ξr2 when the continuously outputtable motor output P is 1.5 kW. In FIG. 27, when the rotor-core outer diameter ør is, for example, 65 mm, the second density ξr2 is approximately 0.15, and the first density ξr1 is approximately 0.175.

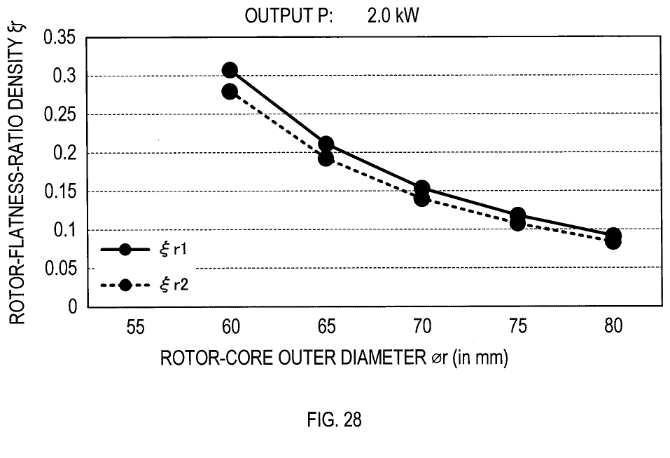

FIG. 28 shows the first and second densities ξr1, ξr2 when the continuously outputtable motor output P is 2.0 kW. In FIG. 28, when the rotor-core outer diameter ør is, for example, 65 mm, the second density ξr2 is approximately 0.19, and the first density ξr1 is approximately 0.21.

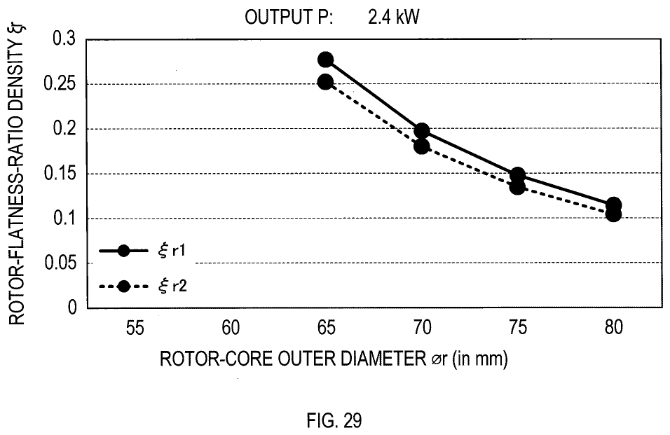

FIG. 29 shows the first and second densities ξr1, ξr2 when the continuously outputtable motor output P is 2.4 kW. In FIG. 29, when the rotor-core outer diameter ør is, for example, 65 mm, the second density ξr2 is approximately 0.25, and the first density ξr1 is approximately 0.28.

From FIG. 26 to FIG. 29, it can be understood that there are suitable ranges for the rotor-flatness ratio ηr and the rotor-flatness-ratio density ξr to realize the desired high output density.

Here, a suitable range for the rotor-flatness-ratio density ξr was investigated.

Among FIG. 26 to FIG. 29, the first density ξr1 is greatest in FIG. 29, i.e., when the output was 2.4 kW. Accordingly, an approximation function was derived for the first density ξr1 in FIG. 29. Although the approximation function may be derived in any manner, the first density ξr1 was approximated with a quadratic function in the present embodiment. The results of the approximation are generally as expressed by Equation (5) below.

$$f ( ∅ r ) = 0.0004650568 ∅ {r}^{2} - 0.0782156446 ∅ r + 3.3960643264 \qquad ( 5 )$$

Accordingly, Equation (1) described above, i.e., fr1, was derived based on the above-mentioned Equation (5) as a numerical formula indicating the upper-limit value for the rotor-flatness-ratio density ξr, allowing for some margin and other considerations.

In addition, among FIG. 26 to FIG. 29, the second density ξr2 is the smallest in FIG. 27, i.e., when the output was 1.5 kW. Accordingly, an approximation function was derived for the second density ξr2 in FIG. 27. The results of the approximation are generally as expressed by Equation (6) below.

$$f ( ∅ r ) = 0.000443 ∅ {r}^{2} - 0.0698 ∅ r + 2.79 \qquad ( 6 )$$

Accordingly, Equation (2) described above, i.e., fr2, was derived based on the above-mentioned Equation (6) as a numerical formula indicating the lower-limit value for the rotor-flatness-ratio density ξr, allowing for some margin and other considerations.

It was thereby concluded that a higher motor output density is possible by designing the motor such that the rotor-flatness-ratio density ξr satisfies the condition fr2≤ξr≤fr1 and the rotor-core outer diameter ør satisfies the condition 55≤ør≤80.

In addition, in FIG. 26 to FIG. 29, it can be said that the rotor-flatness ratio ηr exhibits a trend. Without going into detail, it was concluded, from the evaluation results in FIG. 26 to FIG. 29, that the range for the optimal rotor-flatness ratio ηr at which a high output density can be realized is at least 0.1≤ηr≤0.7.

In FIG. 26 to FIG. 29, the rotor-flatness-ratio density r takes on the minimum value when ør=80 in FIG. 27 (i.e., at an output of 1.5). At this time, because ξr is approximately 0.07, the rotor-flatness ratio ηr is approximately 0.105. In addition, the rotor-flatness-ratio density ξr takes on the maximum value when ør=65 in FIG. 29 (i.e., at an output of 2.4). At this time, based on r1, because ξr is approximately 0.275, the rotor-flatness ratio ηr is approximately 0.66. Accordingly, it can be said that a higher output density becomes possible by setting the rotor-flatness ratio ηr within a range of 0.105≤ηr≤0.66 or, allowing for some margin, within a range of 0.1≤ηr≤0.7.

2-1-4-2d. Seventh and Ninth Conditions

Further conditions for realizing a high output density in a 12-pole, 9-slot configuration were investigated. Specifically, the stator-flatness ratio ηs and the stator-flatness-ratio density ξs were evaluated in the same manner as for the sixth and eighth conditions. The stator-flatness ratio ηs is the ratio of the stator thickness Ds to the stator-core outer diameter øs. The stator-flatness-ratio density ξs is the ratio of the stator-flatness ratio fs per unit of motor output.

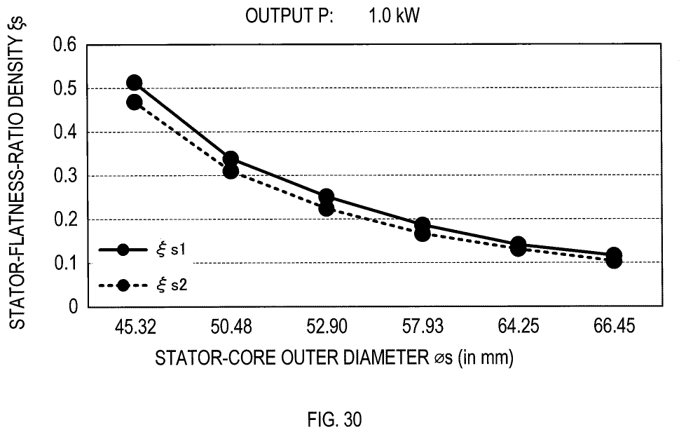

FIG. 30 illustrates the stator-flatness-ratio density ξs for stator-core outer diameters øs corresponding to each rotor-core outer diameter ør under the investigation conditions in FIG. 26. That is, on the abscissa in FIG. 30, “45.32” corresponds to the stator-core outer diameter øs when the rotor-core outer diameter ør=55 in FIG. 26. “50.48” corresponds to the stator-core outer diameter øs when the rotor-core outer diameter ør=60 in FIG. 26. “52.90” corresponds to the stator-core outer diameter øs when the rotor-core outer diameter ør=65 in FIG. 26. “57.93” corresponds to the stator-core outer diameter øs when the rotor-core outer diameter ør=70 in FIG. 26. “64.25” corresponds to the stator-core outer diameter øs when the rotor-core outer diameter ør=75 in FIG. 26. “66.45” corresponds to the stator-core outer diameter øs when the rotor-core outer diameter ør=80 in FIG. 26.

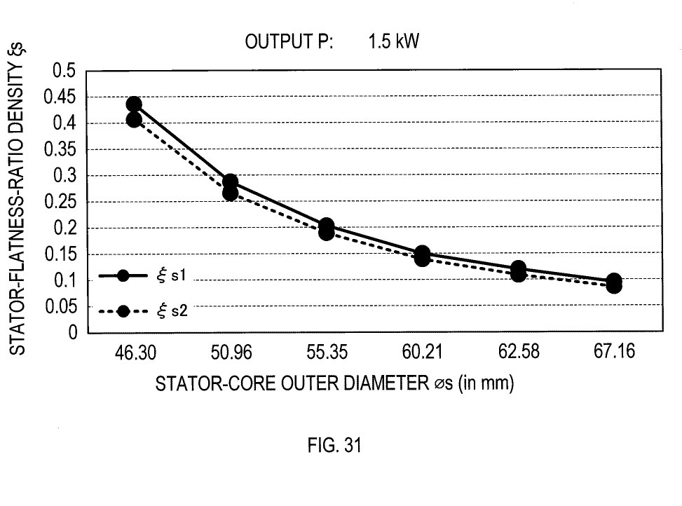

FIG. 31 illustrates the stator-flatness-ratio density ξs for the stator-core outer diameter øs corresponding to each rotor-core outer diameter ør under the investigation conditions in FIG. 27. The correspondence relationship between the abscissa in FIG. 31 and the abscissa in FIG. 27 is the same as the correspondence relationship between FIG. 30 and FIG. 26 described above. To give just one example, “50.96” on the abscissa in FIG. 31 corresponds to the stator-core outer diameter øs when the rotor-core outer diameter ør=60 in FIG. 27.

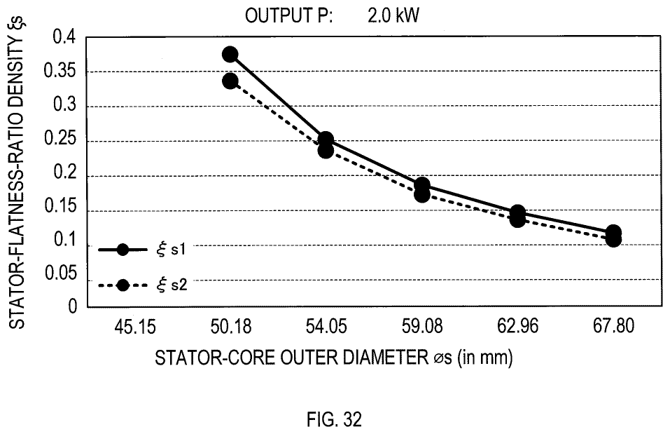

FIG. 32 illustrates the stator-flatness-ratio density ξs for the stator-core outer diameters øs corresponding to each rotor-core outer diameter ør under the investigation conditions in FIG. 28. The correspondence relationship between the abscissa in FIG. 32 and the abscissa in FIG. 28 is the same as the correspondence relationship between FIG. 30 and FIG. 26 described above. To give just one example, “54.05” on the abscissa in FIG. 32 corresponds to the stator-core outer diameter øs when the rotor-core outer diameter ør=65 in FIG. 28.

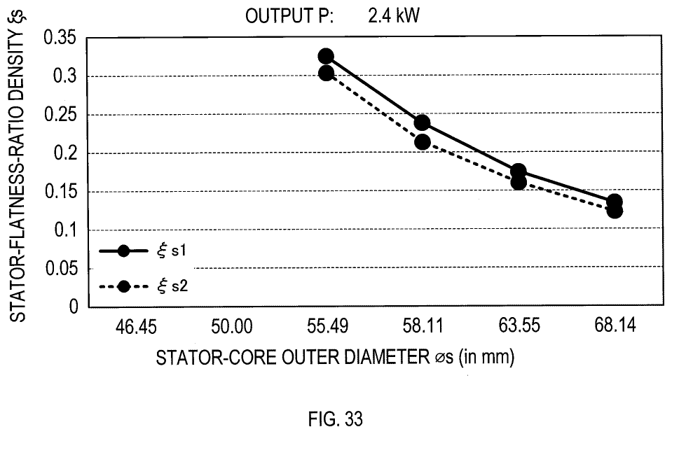

FIG. 33 illustrates the stator-flatness-ratio density ξs for the stator-core outer diameters øs corresponding to each rotor-core outer diameter ør under the investigation conditions in FIG. 29. The correspondence relationship between the abscissa in FIG. 33 and the abscissa in FIG. 29 is the same as the correspondence relationship between FIG. 30 and FIG. 26 described above. To give just one example, “58.11” on the abscissa in FIG. 33 corresponds to the stator-core outer diameter øs when the rotor-core outer diameter ør=70 in FIG. 29.

Furthermore, FIG. 30 illustrates third and fourth densities ξs1, ξs2 under the same investigation conditions as in FIG. 26. The third density ξs1 is the stator-flatness-ratio density ξs when the stator thickness Ds is the maximum value for the optimal stator thickness (i.e., 1.1 times the minimum stator thickness), that is, the stator-flatness-ratio density ξs when the rotor-flatness-ratio density ξr takes on the value of the first density ξr1. The fourth density ξr2 is the stator-flatness-ratio density ξs when the stator thickness Ds is the minimum stator thickness, that is, the stator-flatness-ratio density ξs when the rotor-flatness-ratio density ξr takes on the value of the second density ξr2.

In FIG. 30, when the stator-core outer diameter øs is, for example, 52.90 mm, the fourth density ξs2 is approximately 0.22 and the third density ξs1 is approximately 0.25.

FIG. 31 illustrates the third and fourth densities ξs1, ξs2 under the same investigation conditions as in FIG. 27. In FIG. 31, when the stator-core outer diameter øs is, for example, 55.35 mm, the fourth density ξs2 is approximately 0.18 and the third density ξs1 is approximately 0.2.

FIG. 32 illustrates the third and fourth densities ξs1, ξs2 under the same investigation conditions as in FIG. 28. In FIG. 32, when the stator-core outer diameter øs is, for example, 54.05 mm, the fourth density ξs2 is approximately 0.23 and the third density ξs1 is approximately 0.25.

FIG. 33 illustrates the third and fourth densities ξs1, ξs2 under the same investigation conditions as in FIG. 29. In FIG. 33, when the stator-core outer diameter øs is, for example, 55.49 mm, the fourth density ξs2 is approximately 0.3 and the third density ξs1 is approximately 0.325.

From FIG. 30 to FIG. 33, it can be understood that there are suitable ranges for the stator-flatness ratio fs and the stator-flatness-ratio density ξs to realize the desired high output density.

Therefore, the suitable range for the stator-flatness-ratio density ξs will be investigated in the same manner as for the rotor-flatness-ratio density ξr described above.

Specifically, among FIG. 30 to FIG. 33, the third density ξs1 is greatest in FIG. 33, i.e., when the output is 2.4 kW. Accordingly, an approximation function was derived for the third density ξs1 in FIG. 33. The results of the approximation are generally as expressed by Equation (7) below.

$$f ( ∅ s ) = 0.001050632 ∅ {s}^{2} - 0.1440682961 ∅ s + 5.0766542983 \qquad ( 7 )$$

Accordingly, Equation (3) described above, i.e., fs1, was derived based on the above-mentioned Equation (7) as a numerical formula indicating the upper-limit value of the stator-flatness-ratio density ξs, allowing for some margin and other considerations.

In addition, among FIG. 30 to FIG. 33, the fourth density ξs2 is the smallest in FIG. 31, i.e., when the output is 1.5 kW. Accordingly, an approximation function was derived for the fourth density ξs2 in FIG. 31. The results of the approximation are generally as expressed by Equation (8) below.

$$f ( ∅ s ) = 0.0006647086 ∅ {s}^{2} - 0.0886633681 ∅ s + 3.0478633565 \qquad ( 8 )$$

Accordingly, Equation (4) described above, i.e., fs2, was derived based on the above-mentioned Equation (8) as a numerical formula indicating the lower-limit value of the stator-flatness-ratio density ξs, allowing for some margin and other considerations.

It was thereby concluded that a higher motor output density is possible by designing the motor such that the stator-flatness-ratio density ξs satisfies the condition fs2≤ξs≤fs1 and the stator-core outer diameter øs satisfies the condition 45≤øs≤70. It is noted that the range of the stator-core outer diameter øs was determined based on the fact that the stator-core outer diameters øs are distributed generally within the range of 45-70 in FIG. 30 and FIG. 31.

In addition, in FIG. 30 to FIG. 33, it can also be said that the stator-flatness ratio fs exhibits a trend. Without going into detail, it was concluded, from the evaluation results in FIG. 30 to FIG. 33, that the range for the optimal stator-flatness ratio ηs at which a high output density can be realized is at least 0.1≤ηs≤0.8.

In FIG. 30 to FIG. 33, the stator-flatness-ratio density ξs takes on the minimum value when øs=67.16 in FIG. 31 (i.e., at an output of 1.5). At this time, because ξs is approximately 0.08, the stator-flatness ratio ηs is approximately 0.12. In addition, the stator-flatness-ratio density ξs takes on the maximum value when øs=45.32 in FIG. 30 (i.e., at an output of 1.0). At this time, because ξs is approximately 0.52, the stator-flatness ratio ηs is approximately 0.52. Accordingly, it can be said that a higher output density becomes possible by setting the stator-flatness ratio ηs within a range of 0.12≤ηs≤0.52 or, allowing for some margin, within a range of 0.1≤ηs≤0.8.

2-1-4-2e. Fourth, Fifth, and Tenth Conditions

The basis for the Fourth, Fifth, and Tenth Conditions is the same as the basis for setting the investigation range in Table 1 above. That is, by keeping the rotor-core outer diameter ør within a range of 55≤ør≤80, keeping the stator-core outer diameter øs within a range of 40≤øs≤72.5, and/or keeping the slot-opening width Wso within a range of 0.04 øs≤Wso≤0.18 øs, it is possible to realize a motor that satisfies the desired design requirements (including a high output density) while being based on the preconditions described above.

### Supplementary Explanation Regarding Effectiveness of 12-Pole, 9-Slot Configuration

A supplementary explanation regarding the effectiveness of a 12-pole, 9-slot configuration will now be provided. By adopting a 12-pole, 9-slot configuration, it is possible to make the motor lighter in weight in addition to making the motor more compact while still achieving a higher output density. That is, from among the various pole-slot combinations shown in the investigation range in Table 1, a 12-pole, 9-slot configuration is the one that can make the motor lightest in weight (without sacrificing performance).

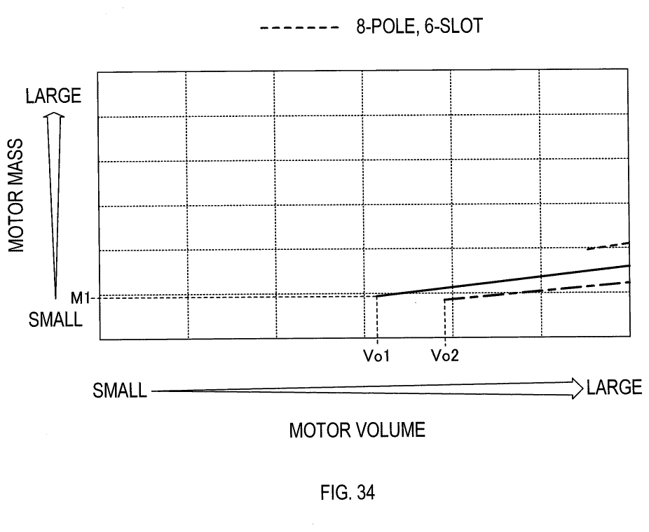

FIG. 34 is a schematic derivation of the relationship between motor volume and mass in the various combinations described above based on the investigation ranges in Table 1.

In FIG. 34, only a 12-pole, 9-slot combination, a 14-pole, 12-slot combination, and an 8-pole, 6-slot combination are shown. This means that the characteristics of other pole-slot combinations are outside the scope of the graph in FIG. 34.

Accordingly, from among the plurality of pole-slot combinations, a 12-pole, 9-slot combination, a 14-pole, 12-slot combination, and an 8-pole, 6-slot combination can be used to further reduce volume and mass under the preconditions described above.

Furthermore, a 12-pole, 9-slot configuration in particular can most reduce volume and mass. That is, if a 12-pole, 9-slot configuration is used, then at least a motor having a volume of Vo1 and a mass of M1 can be realized. If a 14-pole, 12-slot configuration is used, then at least a volume greater than Vo1 (at least Vo2) is required to provide equivalent performance. If an 8-pole, 6-slot configuration is used, then a volume even greater than Vo2 is required to maintain equivalent performance, and mass also becomes greater than M1.

### 2-2. Second Embodiment

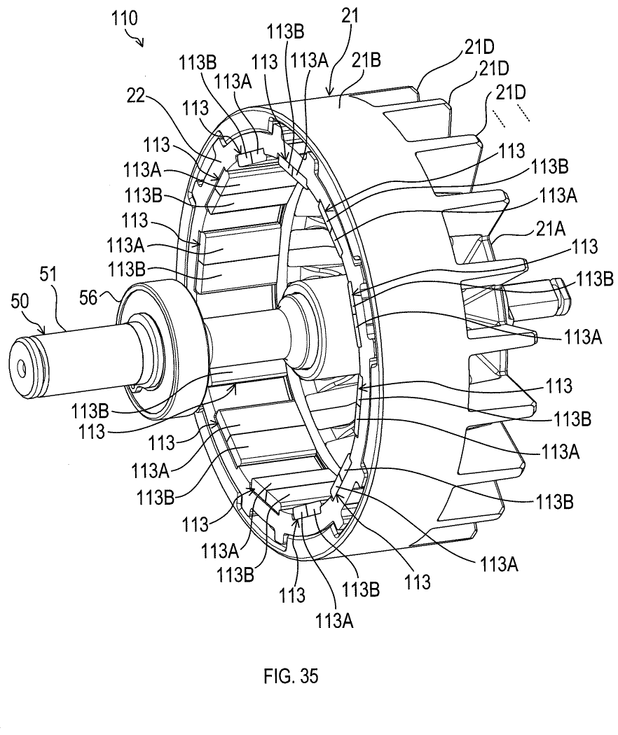

The second embodiment illustrates another embodiment of the rotor according to the present disclosure. As shown in FIG. 35, the form of the magnets in a rotor 110 according to the second embodiment differs from that of the magnets in the rotor 20 according to the first embodiment. The rotor 110 according to the second embodiment comprises twelve (in detail, twelve sets or twelve groups of) magnets 113. The magnets 113 are permanent magnets.

The magnets 113 are divided into multiple portions in the circumferential direction. In the present second embodiment, the magnets 113 are divided into two portions in the circumferential direction. Specifically, each of the magnets 113 includes a first portion 113A and a second portion 113B. The second portion 113B is separate from the first portion 113A in each magnet 113.

The magnets 113 can be regarded as the magnets 23 of the first embodiment divided into two portions. The magnetic properties of the magnets 113 are in fact equivalent to those of the magnets 23 in the first embodiment when divided into two portions. It is noted that the first portions 113A and the second portions 113B may be in contact with each other or may be spaced apart from each other.

The shapes and sizes of the first portions 113A are the same as the shapes and sizes of the second portions 113B. However, the first portions 113A and the second portions 113B may differ in shape and/or size. In addition, the magnets 113 may be divided into three or more portions in the circumferential direction.

By dividing the magnets 113 into multiple portions in this manner, losses (e.g., eddy-current losses) occurring in the magnets 113 can be reduced compared with the magnets 23 in the first embodiment.

### 2-3. Third Embodiment

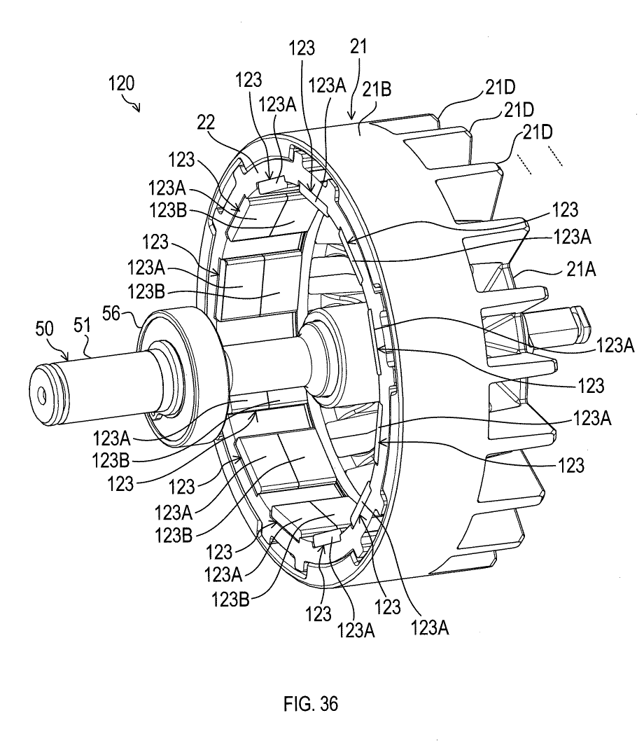

The third embodiment illustrates yet another embodiment of the rotor according to the present disclosure. As shown in FIG. 36, the form of the magnets in a rotor 120 according to the third embodiment differs from the form of the magnets in the rotor 20 according to the first embodiment. The rotor 120 according to the third embodiment comprises twelve (in detail, twelve sets or twelve groups of) magnets 123. The magnets 123 are permanent magnets.

The magnets 123 are divided into multiple portions in the axial direction. In the present third embodiment, the magnets 123 are divided into two portions in the axial direction. Specifically, each of the magnets 123 includes a first portion 123A and a second portion 123B. The second portion 123B is separate from the first portion 123A in each magnet 123.

The magnets 123 can be regarded as the magnets 23 of the first embodiment divided into two portions. The magnetic properties of the magnets 123 are in fact equivalent to those of the magnets 23 in the first embodiment when divided into two portions. It is noted that the first portions 123A and the second portions 123B may be in contact with each other or may be spaced apart from each other.

The shapes and sizes of the first portions 123A are the same as the shapes and sizes of the second portions 123B. However, the first portions 123A and the second portions 123B may differ in shape and/or size. In addition, the magnets 123 may be divided into three or more portions in the axial direction.

By dividing the magnets 123 into multiple portions in this manner, losses (e.g., eddy-current losses) occurring in the magnets 123 can be reduced compared with the magnets 23 in the first embodiment, as in the second embodiment.

### 2-4. Other Embodiments

Although embodiments of the present disclosure have been described above, the present disclosure is not limited to the embodiments described above, and various modifications can be implemented.

(1) The electric work machine 1 according the above embodiments is in the form of a power chain saw. However, the electric work machine 1 may be in a form other than a power chain saw. Specifically, the electric work machine 1 may be in the form of any of the various types of apparatuses configured for use at work sites, such as construction sites, manufacturing sites, gardening sites, civil engineering sites, etc., described above.

(2) The electric work machine 1 may be configured to be capable of being driven by receiving AC power from an AC power supply instead of or in addition to the battery pack 12. In such an embodiment, the electric work machine 1 comprises a power cord that supplies electric power (current) from, e.g., a commercial AC power supply (mains power) to the controller and motor of the electric work machine 1.

### 2-5. Supplementary Explanation

In the above-mentioned embodiments, a plurality of functions achieved by one component may be achieved by a plurality of components, and one function achieved by one component may be achieved by a plurality of components. In addition, a plurality of functions achieved by a plurality of components may be achieved by one component, and one function achieved by a plurality of components may be achieved by one component. In addition, a portion of the configurations of the above-mentioned embodiments may be omitted. In addition, at least a portion of the configuration of one of the above-mentioned embodiments may be added to or substituted for the configuration of another one of the above-mentioned embodiments.

### EXPLANATION OF THE REFERENCE NUMBERS

1 Electric work machine
5 Battery-mounting part
6 Motor
10 Saw chain
11 Controller
12 Battery pack
13 Motive-power-transmitting part
20, 110, 120 Rotors
21 Rotor cup
22 Rotor core
23, 113, 123 Magnets
30 Stator
31 Stator core
31A Yoke
31B Tooth
33 Coil
34 Slot
50 Rotor shaft

1. An electric work machine comprising:
an outer-rotor-type brushless motor; and
a motive-power-transmitting part configured to transmit rotational force of the brushless motor to a tool accessory to drive the tool accessory;
wherein the brushless motor comprises:
a rotor comprising a rotor core, which has a tubular shape and has twelve magnetic poles disposed spaced apart from each other along a circumferential direction of the rotor core, the rotor core comprising a plurality of first core sheets laminated to each other; and
a stator comprising a stator core, which is disposed within the rotor core and comprises nine teeth, and nine coils respectively wound around the nine teeth, the stator core comprising a plurality of second core sheets laminated to each other.

2. The electric work machine according to claim 1, wherein:
the brushless motor has a back-EMF constant k (in V/krpm) that satisfies the condition 1.1≤k≤9.0; and
the back-EMF constant k is calculated by using numerical formula E/N, wherein:
N (in krpm) is rotational speed of the rotor; and
E (in V) is a value indicating a magnitude of back EMF generated by the brushless motor when the rotor is rotating at rotational speed N.

3. The electric work machine according to claim 1, wherein:
the brushless motor has a coefficient α (in mΩ/(V/krpm)²) that satisfies the condition 0.2≤α≤19.0; and
the coefficient α is calculated using numerical formal R/k², wherein:
R (in mΩ) is a motor-resistance value based on a resistance value of at least one of the nine coils; and
k (in V/krpm) is calculated using numerical formula E/N, wherein N (in krpm) is rotational speed of the rotor and E (in V) is a value indicating a magnitude of back EMF generated by the brushless motor when the rotor is rotating at rotational speed N.

4. The electric work machine according to claim 1, wherein:
the rotor core has a rotor-core outer diameter ør (in mm) that satisfies the condition 55≤ør≤80; and
the rotor-core outer diameter ør is the outer diameter of the rotor core.

5. The electric work machine according to claim 1, wherein:
the stator core has a stator-core outer diameter øs (in mm) that satisfies the condition 40≤øs≤72.5; and
the stator-core outer diameter øs is the outer diameter of the stator core.

6. The electric work machine according to claim 1, wherein:
the brushless motor has a rotor-flatness ratio ηr that satisfies the condition 0.1≤ηr≤0.7; and
the rotor-flatness ratio ηr is calculated using numerical formula Ds/ør, wherein:
Ds (in mm) is the length of the stator core in an axial direction, the axial direction being parallel to the rotational axis of the rotor; and
ør (in mm) is the outer diameter of the rotor core.

7. The electric work machine according to claim 1, wherein:
the brushless motor has a stator-flatness ratio ηs that satisfies the condition 0.1≤ηs≤0.8; and
the stator-flatness ratio ηs is calculated using numerical formula Ds/øs;
wherein:
Ds (in mm) is the length of the stator core in an axial direction, the axial direction being parallel to the rotational axis of the rotor; and
øs (in mm) is the outer diameter of the stator core.

8. The electric work machine according to claim 1, wherein:
the brushless motor has a rotor-flatness-ratio density ξr (in kW⁻¹) that satisfies the condition fr2≤ξr≤fr1; and
the rotor-flatness-ratio density ξr is calculated using the numerical formula ηr/P, wherein:
ηr is calculated using the numerical formula Ds/ør, wherein:
Ds (in mm) is the length of the stator core in an axial direction, the axial direction being parallel to the rotational axis of the rotor; and
ør (in mm) is the outer diameter of the rotor core and satisfies 55≤ør≤80; and
P (in kW) is the output of the brushless motor; and
fr1 and fr2 satisfy the following two equations:
$$fr 1 = 0.000465 ∅ {r}^{2} - 0.0782 ∅ r + 3.43$$
$$fr 2 = 0.000443 ∅ {r}^{2} - 0.0698 ∅ r + 2.79 .$$

9. The electric work machine according to claim 1, wherein:
the brushless motor has a stator-flatness-ratio density ξs (in kW⁻¹) that satisfies the condition fs2≤ξs≤fs1; and
the stator-flatness-ratio density ξs is calculated using numerical formula ηs/P;
wherein:
ηs is calculated using numerical formula Ds/øs, wherein:
Ds (in mm) is the length of the stator core in an axial direction, the axial direction being parallel to the rotational axis of the rotor; and
øs (in mm) is the outer diameter of the stator core and satisfies 45≤øs≤70; and
P (in kW) is the output of the brushless motor; and
fs1 and fs2 satisfy the following two equations:
$$fs 1 = 0.00105 ∅ {s}^{2} - 0.144 ∅ s + 5.13$$
$$fs 2 = 0.000665 ∅ {s}^{2} - 0.0887 ∅ s + 3. .$$

10. The electric work machine according to claim 1, wherein:
the rotor core comprises twelve magnet parts; and
the twelve magnet parts (i) are disposed spaced apart from each other along a rotational direction of the rotor core, (ii) each comprise one or more permanent magnets, and (iii) each constitute a corresponding one of the twelve magnetic poles.

11. The electric work machine according to claim 10, wherein the one or more permanent magnets include a sintered magnet containing neodymium, iron, and boron.

12. The electric work machine according to claim 10, wherein the twelve magnet parts are mounted on an inner-circumferential surface of the rotor core.

13. The electric work machine according to claim 10, wherein each of the twelve magnet parts includes two or more permanent magnets that are independent of each other.

14. The electric work machine according to claim 13, wherein, in each of the twelve magnet parts, the two or more permanent magnets are disposed along the circumferential direction of the rotor core.

15. The electric work machine according to claim 13, wherein, in each of the twelve magnet parts, the two or more permanent magnets are disposed along a rotational axis of the rotor core.

16. The electric work machine according to claim 1, wherein the nine coils are delta-connected.

17. The electric work machine according to claim 16, wherein:
the stator comprises a first coil group, a second coil group, and a third coil group, which are delta-connected to each other;
the first coil group includes three coils, from among the nine coils, that are connected in parallel to each other;
the second coil group includes three coils, from among the nine coils, that are different from those of the first coil group and are connected in parallel to each other; and
the third coil group includes three coils, from among the nine coils, that are different from those of the first coil group and the second coil group and are connected in parallel to each other.

18. The electric work machine according to claim 1, wherein:
the stator core has a slot-opening width Wso (in mm) that satisfies the condition 0.04 øs≤Wso≤0.18 øs; and
the slot-opening width Wso is a straight-line distance along the circumferential direction of a radially outward opening between two of the nine teeth that are adjacent in the circumferential direction.

19. The electric work machine according to claim 1, further comprising:
a grip portion configured to be gripped by a user of the electric work machine; and/or
a battery-mounting part configured for a battery pack, which includes a battery, to be mounted thereupon in a detachable manner.
